(19) United States
(12) Patent Application Publication
(10) Pub. No.: US 2025/0211763 A1
(43) Pub. Date: Jun. 26, 2025

(54) CODING METHOD AND APPARATUS, DECODING METHOD AND APPARATUS, AND CODER, DECODER AND STORAGE MEDIUM

(71) Applicant: GUANGDONG OPPO MOBILE TELECOMMUNICATIONS CORP., LTD., Dongguan (CN)

(72) Inventors: Yanzhuo MA, Dongguan (CN); Junyan HUO, Dongguan (CN); Ruipeng QIU, Dongguan (CN); Hongli ZHANG, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/077,385

(22) Filed: Mar. 12, 2025

Related U.S. Application Data
(63) Continuation of application No. PCT/CN2022/118455, filed on Sep. 13, 2022.

(51) Int. Cl. H04N 19/196; H04N 19/176; H04N 19/70

(52) U.S. Cl. CPC H04N 19/196; H04N 19/176; H04N 19/70

(57) ABSTRACT

Disclosed in the present invention are a coding method and apparatus, a decoding method and apparatus, and a coder, a decoder and a storage medium. The decoding method comprises: acquiring a geometrical partition mode (GPM) prediction parameter of the current block; determining a plurality of candidate transition width parameters according to the prediction parameter; on the basis of template matching, determining a first transition width parameter actually used by a weight matrix of the current block; obtaining weight values of pixel points of the current block according to the first transition width parameter; and performing pixel-by-pixel weighting on a first predicted value and a second predicted value of the current block according to the weight values to obtain a predicted value of the current block.

### CROSS-REFERENCE TO RELATED APPLICATIONS

This application is a continuation of International Application No. PCT/CN2022/118455, filed on Sep. 13, 2022, the disclosure of which is hereby incorporated by reference in its entirety.

### TECHNICAL FIELD

This application relates to the field of video image processing technologies, and in particular, to a coding method and apparatus, an encoder, a decoder, and a storage medium.

### BACKGROUND

In a hybrid video encoding framework, encoding technologies such as prediction, transformation, and quantization are generally implemented by in the unit of square or rectangular. However, in practice, an edge of a moving object is not necessarily in a horizontal or vertical direction. In addition, motion vectors on two sides of a moving edge are often different, and a dividing line may not be drawn onto an edge of the object accurately. In this case, motion prediction and compensation performed based on an entire block in an encoding process tends to generate a relatively large prediction error, thereby causing limited encoding efficiency.

In a Joint Video Experts Team (JVET) meeting, an inter geometric partitioning mode (GPM) that is more flexible than TPM is introduced. GPM allows partitioning of a coding block into two non-rectangular parts. Unidirectional prediction is separately performed on the two parts, and then weighted fusion is performed, to obtain a final predicted value.

In a GPM prediction process, a GPM weight matrix has a fixed weight transition width at a dividing line. Considering effects of a moving speed and a sequence resolution of a moving object, a fixed weight transition width at a dividing line is not an optimal solution.

### SUMMARY

Embodiments of this application provide a coding method and apparatus, an encoder, a decoder, and a storage medium.

According to a first aspect, an embodiment of this application provides a decoding method, including:
obtaining, for a current block, a prediction parameter of a geometric partitioning mode;
determining, based on the prediction parameter, a plurality of candidate transition width parameters of a weight matrix of the current block;
determining, based on template matching, a first transition width parameter from the plurality of candidate transition width parameters;
obtaining a weight value for a sample of the current block according to the first transition width parameter; and
performing, weighting on a first predicted value and a second predicted value of the current block according to the weight value of the sample of the current block, to obtain a predicted value of the current block.

According to a second aspect, an embodiment of this application provides an encoding method, including:
obtaining, for a current block, a prediction parameter of a geometric partitioning mode;
determining, based on the prediction parameter, a plurality of candidate transition width parameters of a weight matrix of the current block;
determining, based on template matching, template matching cost parameters of the plurality of candidate transition width parameters;
sorting the plurality of candidate transition width parameters according to the template matching cost parameters, to obtain index parameters of the plurality of candidate transition width parameters;
determining a first transition width parameter from the plurality of candidate transition width parameters;
determining an index parameter of the first transition width parameter from the index parameters of the plurality of candidate transition width parameters; and
encoding the index parameter of the first transition width parameter, to obtain a bitstream.

According to a third aspect, an embodiment of this application provides an encoding method, including:
obtaining, for a current block, a prediction parameter of a geometric partitioning mode;
determining, based on the prediction parameter, a plurality of candidate transition width parameters of a weight matrix of the current block;
determining, based on template matching, template matching cost parameters of the plurality of candidate transition width parameters;
sorting the plurality of candidate transition width parameters according to the template matching cost parameters, and selecting a candidate transition width parameter corresponding to a least template matching cost parameter as the first transition width parameter;
obtaining a weight value for a sample of the current block according to the first transition width parameter; and
performing weighting on a first predicted value and a second predicted value of the current block according to the weight value for the sample of the current block, to obtain a predicted value of the current block.

According to a fourth aspect, an embodiment of this application provides a decoding apparatus, including:
an obtaining unit, configured to obtain, for a current block, a prediction parameter of a geometric partitioning mode;
a determining unit, configured to determine, based on the prediction parameter, a plurality of candidate transition width parameters of a weight matrix of the current block;
a first processing unit, configured to determine, based on template matching, a first transition width parameter from the plurality of candidate transition width parameters; and
a prediction unit, configured to: obtain a weight value for a sample of the current block according to the first transition width parameter; and perform weighting on a first predicted value and a second predicted value of the current block according to the weight value for the sample of the current block, to obtain a predicted value of the current block.

According to a fifth aspect, an embodiment of this application provides an encoding apparatus, including:
an obtaining unit, configured to obtain, for a current block, a prediction parameter of a geometric partitioning mode;
a determining unit, configured to determine, based on the prediction parameter, a plurality of candidate transition width parameters of a weight matrix of the current block;
a first processing unit, configured to: determine template matching cost parameters of the plurality of candidate transition width parameters; and sort the plurality of candidate transition width parameters according to the template matching cost parameters, to obtain index parameters of the plurality of candidate transition width parameters;
a second processing unit, configured to determine a first transition width parameter from the plurality of candidate transition width parameters,
the first processing unit further configured to determine an index parameter of the first transition width parameter from the index parameters of the plurality of candidate transition width parameters; and
an encoding unit, configured to encode the index parameter of the first transition width parameter, to obtain a bitstream.

According to a sixth aspect, an embodiment of this application provides an encoding apparatus, including:
an obtaining unit, configured to obtain, for a current block, a prediction parameter of a geometric partitioning mode;
a determining unit, configured to determine, based on the prediction parameter, a plurality of candidate transition width parameters of a weight matrix of the current block;
a first processing unit, configured to: determine template matching cost parameters of the plurality of candidate transition width parameters; and sort the plurality of candidate transition width parameters according to the template matching cost parameters, and select a candidate transition width parameter corresponding to a least template matching cost parameter as the first transition width parameter; and
a prediction unit, configured to: obtain a weight value for a sample of the current block according to the first transition width parameter; and perform weighting on a first predicted value and a second predicted value of the current block according to the weight value for the sample of the current block, to obtain a predicted value of the current block.

According to a seventh aspect, a decoder is provided, including a first memory and a first processor, where the first memory stores a computer program that is runnable on the first processor, to execute the method according to the first aspect or implementations of the first aspect.

According to an eighth aspect, an encoder is provided, including a second memory and a second processor, where the second memory stores a computer program that is runnable on the second processor, to execute the method according to the second aspect, the third aspect, or implementations of the second aspect and the third aspect.

According to a ninth aspect, a codec system is provided, including an encoder and a decoder. The encoder is configured to execute the method according to the second aspect, the third aspect, or the implementations thereof, and the decoder is configured to execute the method according to the first aspect or implementations of the first aspect.

According to a tenth aspect, a chip is provided and is configured to implement the method according to any one of the first aspect to the third aspect or implementations of the first aspect to the third aspect. Specifically, the chip includes a processor, configured to invoke a computer program from a memory and run the computer program, to cause a device on which the chip is installed to execute the method according to any one of the first aspect to the third aspect or implementations of the first aspect to the third aspect.

According to an eleventh aspect, a computer-readable storage medium is provided and is configured to store a computer program. The computer program causes a computer to execute the method according to any one of the first aspect and the second aspect or implementations of the first aspect and the second aspect.

According to a twelfth aspect, a computer program product is provided, including computer program instructions. The computer program instructions cause a computer to execute the method according to any one of the first aspect and the second aspect or implementations of the first aspect and the second aspect.

According to a thirteenth aspect, a computer program is provided, where when running on a computer, the computer program causes the computer to execute the method according to any one of the first aspect and the second aspect or implementations of the first aspect and the second aspect.

According to a fourteenth aspect, a bitstream is provided, including an index parameter of a first transition width parameter.

According to the technical solutions in embodiments of this application, a plurality of candidate transition width parameters are sorted through template matching, and an optimal transition width parameter is selected from a sorting result for a current block, to determine an optimal weight matrix of the current block.

### BRIEF DESCRIPTION OF DRAWINGS

FIG. 1 is a schematic block diagram of an encoder according to an embodiment of this application.

FIG. 2 is a schematic block diagram of a decoder according to an embodiment of this application.

FIG. 3 is a first schematic flowchart of an encoding method according to an embodiment of this application.

FIG. 4 is a schematic flowchart of a method for determining a first transition width parameter according to an embodiment of this application.

FIG. 5 is a schematic diagram of a correspondence between a distance from a pixel to a dividing line and a weight value according to an embodiment of this application.

FIG. 6 is a schematic flowchart of a template matching method according to an embodiment of this application.

FIG. 7a is a schematic diagram of a first location relationship of a related area of a current block according to an embodiment of this application.

FIG. 7b is a schematic diagram of a second location relationship of a related area of a current block according to an embodiment of this application.

FIG. 8 is a second schematic flowchart of an encoding method according to an embodiment of this application.

FIG. 9 is a first schematic flowchart of a decoding method according to an embodiment of this application.

FIG. 10 is a schematic diagram of GPM partitioning under different angles and offsets according to an embodiment of this application.

FIG. 11a is a first schematic diagram of a GPM with inter and intra mode according to an embodiment of this application.

FIG. 11b is a second schematic diagram of a GPM with inter and intra mode according to an embodiment of this application.

FIG. 11c is a third schematic diagram of a GPM with inter and intra mode according to an embodiment of this application.

FIG. 12a is a fourth schematic diagram of a GPM with inter and intra mode according to an embodiment of this application.

FIG. 12b is a fifth schematic diagram of a GPM with inter and intra mode according to an embodiment of this application.

FIG. 13 is a schematic block diagram 1 of an encoding apparatus according to an embodiment of this application.

FIG. 14 is a schematic block diagram 2 of an encoding apparatus according to an embodiment of this application.

FIG. 15 is a schematic block diagram of a decoding apparatus according to an embodiment of this application.

FIG. 16 is a schematic block diagram of an encoder according to an embodiment of this application.

FIG. 17 is a schematic block diagram of a decoder according to an embodiment of this application.

FIG. 18 is a schematic structural diagram of a codec system according to an embodiment of this application.

### DESCRIPTION OF EMBODIMENTS

To understand features and technical contents of embodiments of this application in more detail, the following describes implementation of embodiments of this application in detail with reference to the accompanying drawings. The accompanying drawings are merely used for description, and are not intended to limit embodiments of this application.

The following describes embodiments of this application in detail with reference to the accompanying drawings.

Currently, block-based hybrid coding is used in all common video coding standards (for example, VVC). Each frame in a video is divided into largest coding units (LCU), or referred to as coding tree units (CTU), which are square and have a same size (for example, 128×128 or 64×64). Each largest coding unit may be divided into rectangular coding units (CU) according to a rule. A coding unit may be further divided into prediction units (PU), transform units (TU), and the like.

At an encoding end, a frame of image is divided into blocks. For a current block (CU), intra prediction or inter prediction is used to generate a predicted block of the current block. The predicted block is subtracted from an original block of the current block, to obtain a residual block. The residual block is transformed and quantized, to obtain a quantization coefficient matrix. Then, the quantization coefficient matrix is entropy coded and output into a bitstream.

Exemplarily, FIG. 1 shows a video encoding system. As shown in FIG. 1, the video encoding system 11 includes a transform unit 111, a quantization unit 112, a mode selection and encoding control logic unit 113, an intra prediction unit 114, an inter prediction unit 115 (including motion compensation and motion estimation), a dequantization unit 116, an inverse transform unit 117, an in-loop filtering unit 118, an encoding unit 119, and a decoded image buffer unit 110. For an input original video signal, a frame of image is divided into blocks, an encoding mode is determined by the mode selection and encoding control logic unit 113, and a predicted block of a current block is generated through intra prediction or inter prediction of the current block. Due to strong correlation between adjacent pixels in a frame of a video, spatial redundancy between adjacent pixels is eliminated by using an intra prediction method in a video coding technology. Due to strong similarity between adjacent frames in a video, time redundancy between adjacent frames is eliminated by using an inter prediction method in a video coding technology, thereby improving encoding efficiency. A predicted block is subtracted from an original block of a current block, to obtain a residual block, and the residual block is processed by the transform unit 111 and the quantization unit 112, to obtain a quantization coefficient matrix. The quantization coefficient matrix is entropy coded by the encoding unit 119 and output into a bitstream. In addition, the quantization coefficient matrix is processed by the dequantization unit 116 and the inverse transform unit 117, to obtain a reconstructed residual block. The reconstructed residual block is processed by the in-loop filtering unit 118, to remove a block artifact, and then the reconstructed residual block is added to a predicted block of a frame in the decoded image buffer unit 110, to generate a reconstructed video reconstruction block. The decoded image buffer unit 110 is configured to store the reconstructed video reconstruction block for prediction reference. As video image encoding is performed, new reconstructed video reconstruction blocks are continuously generated, and these reconstructed video reconstruction blocks are all stored in the decoded image buffer unit 110.

A decoding end determines, through parsing or analysis based on existing information, block partitioning information and mode information or parameter information of prediction, transformation, quantization, entropy coding, in-loop filtering, and the like, which are the same as those at the encoding end. This ensures that a decoded image obtained at the encoding end is the same as a decoded image obtained at the decoding end.

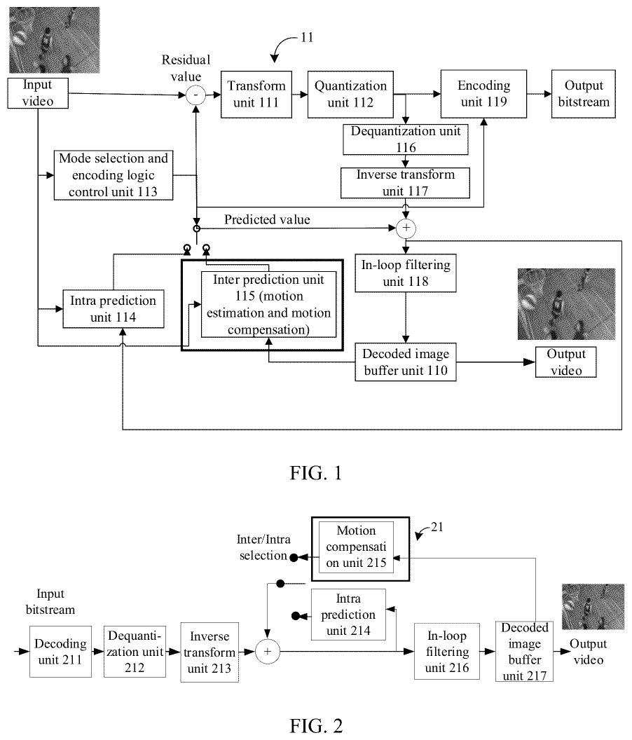

Exemplarily, FIG. 2 shows a video decoding system. FIG. 2 is a schematic structural diagram of a video decoding system according to an embodiment of this application. As shown in FIG. 2, the video decoding system 21 includes a decoding unit 211, a dequantization unit 212, an inverse transform unit 213, an intra prediction unit 214, a motion compensation unit 215, an in-loop filtering unit 216, and a decoded image buffer unit 217. Encoding processing is performed on an input video signal by using the video encoding system 11 and a bitstream of the video signal is output. The bitstream is input into the video decoding system 21. First, the bitstream is processed by the decoding unit 211, to obtain a decoded quantization coefficient matrix. The quantization coefficient matrix is processed by the dequantization unit 213 and the inverse transform unit 212, to generate a residual block in a pixel domain. The intra prediction unit 214 may be configured to generate a predicted block of a current video block based on a determined intra prediction direction and decoded data from a current frame or image. The motion compensation unit 215 determines prediction information used for the current block by parsing motion vectors and other associated syntax elements, and uses the prediction information to generate the predicted block of the current block. A sum of the residual block from the inverse transform unit 212 and the dequantization unit 213 and the corresponding predicted block generated by the intra prediction unit 214 or the motion compensation unit 215 is calculated, to form a decoded reconstructed block. The decoded reconstructed block is processed by the in-loop filtering unit 216 to remove a block artifact, which may improve video quality. Then, the decoded reconstructed block is stored in the decoded image buffer unit 217, and the decoded image buffer unit 217 stores a reference image that is used for subsequent intra prediction or motion compensation and also used for outputting of a video signal, to obtain the restored original video signal.

It should be noted that the methods in embodiments of this application are mainly applied to the inter prediction unit 115 shown in FIG. 1 and the motion compensation unit 215 shown in FIG. 2. That is, embodiments of this application may be applied to an encoder or a decoder, or may be applied to both an encoder and a decoder. However, embodiments of this application set no specific limitation thereto.

Based on this, the following further describes the technical solutions of this application in detail with reference to the accompanying drawings and embodiments. Before detailed descriptions, it should be noted that the “first”, “second”, “third”, and the like mentioned throughout the specification are merely intended to distinguish different features, and are not intended to define a priority, a sequence, or a size relationship.

An embodiment of this application provides an encoding method, and the method is applied to a video encoding device, that is, an encoder. Functions implemented in the method may be implemented by invoking program code by a processor in the video encoding device. Certainly, the program code may be stored in a computer storage medium. It may be learned that the video encoding device at least includes a processor and the storage medium.

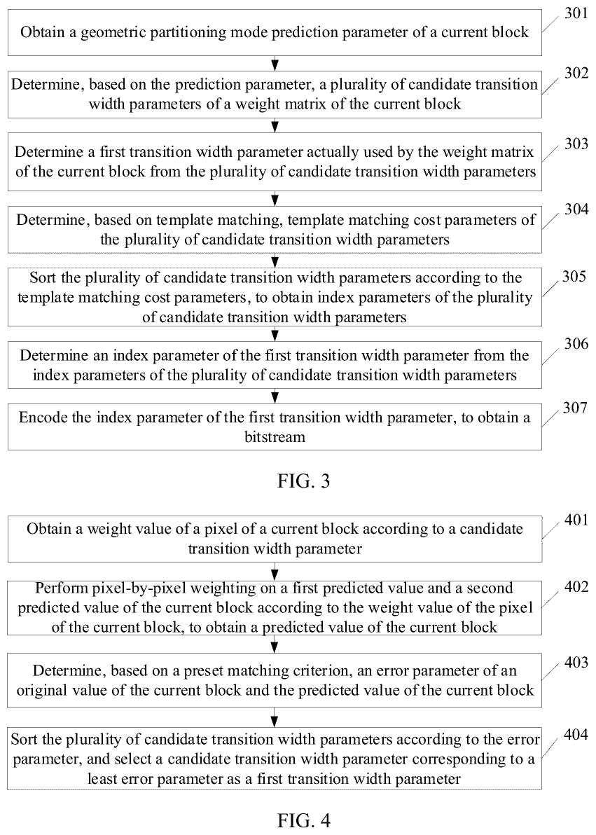

FIG. 3 is a first schematic flowchart of an encoding method according to an embodiment of this application. As shown in FIG. 3, the method includes the following steps.

Step 301: Obtain a geometric partitioning mode prediction parameter of a current block.

Step 302: Determine, based on the prediction parameter, a plurality of candidate transition width parameters of a weight matrix of the current block.

It should be noted that the prediction parameter at least includes a parameter used to indicate an selection range of the candidate transition width parameters.

A transition width parameter (weightTransitionWidthIdx) is a parameter that represents a transition width (weightTransitionWidth) of a weight matrix. The transition width represents, in a unit of pixel, a transition pixel width of the weight matrix at a dividing line. The transition width parameter may be the transition width or a control variable of the transition width. In some embodiments, the selection range of the transition width may include quantities of pixels that are powers of 2, for example, 1, 2, 4, 8, 16, 32, or 64. Exemplarily, a selection range of the transition width is 2, 4, or 8, or the selection range of the transition width is 1, 2, 4, 8, 16, and 32. In some embodiments, the selection range of the transition width may include a quantity of pixels that is not a power of 2, for example, 0, 3, 5, or 7.

In some embodiments, the transition width parameter is a logarithm of the transition width with a base of 2. When the selection range of the transition width is 1, 2, 4, 8, 16, or 32, correspondingly, a selection range of the candidate transition width parameters is 0, 1, 2, 3, 4, or 5.

Exemplarily, in some embodiments, the prediction parameter includes a first syntax element used to indicate the plurality of candidate transition width parameters.

Exemplarily, the first syntax element is comprised in a sequence parameter set, a picture parameter set, a picture header data unit, a slice header data unit, or a current block data unit. That is, the selection range of the transition width of the weight matrix may be adjusted in high-level syntax such as a sequence parameter set (SPS) or a picture parameter set (SPS). Alternatively, the selection range of the transition width of the weight matrix is indicated in a picture header data unit (picture header, PH), a slice header data unit (slice header, SH), or a current block data unit (CU layer). For example, the selection range of the transition width of the weight matrix is controlled to range from 4 to 16.

Exemplarily, in some embodiments, the prediction parameter includes a size of the current block, a resolution of the current block, a quantization parameter of the current block, or a difference between motion vectors of two parts of the current block.

A larger size of the current block indicates a larger transition width, and a smaller size of the current block indicates a smaller transition width. A higher resolution of the current block indicates a larger transition width, and a lower resolution of the current block indicates a smaller transition width. A smaller quantization parameter of the current block indicates a larger transition width, and a larger quantization parameter of the current block indicates a smaller transition width. A larger difference between motion vectors of the two parts indicates a larger transition width, and a smaller difference between motion vectors of the two parts indicates a smaller transition width.

In some embodiments, an upper limit and/or a lower limit of the selection range of the transition width may be determined based on these prediction parameters, that is, an upper limit or a lower limit or both of the selection range of the candidate transition width parameters are determined, and the plurality of candidate transition width parameters are selected from the selection range.

Step 303: Determine a first transition width parameter actually used by the weight matrix of the current block from the plurality of candidate transition width parameters.

Herein, the first transition width parameter represents an optimal transition width that leads to the least error between a predicted value and an original value of the current block. Based on a preset matching criterion, an encoding end calculates, for different transition widths, error parameters between an original value of the current block and weighted predicted values obtained by using weight matrices with the respective transition widths, and selects a transition width corresponding to the least error parameter as the first transition width parameter.

Exemplarily, FIG. 4 is a schematic flowchart of a method for determining a first transition width parameter according to an embodiment of this application. As shown in FIG. 4, the determining a first transition width parameter actually used by the weight matrix of the current block from the plurality of candidate transition width parameters includes the following steps.

Step 401: Obtain a weight value of a pixel of the current block according to a candidate transition width parameter.

There are a total of 64 partitioning modes in a geometric partitioning mode (GPM) technology, where each partitioning mode corresponds to an angle α and a step ρ, and there are a total of 20 angles and four steps. GPM allows partitioning of a coding block into two non-rectangular parts. Unidirectional prediction is separately performed on the two parts, and then weighted fusion is performed, to obtain a final predicted value. In H.266 or VVC, when the current block is in a GPM mode, a corresponding angle angleIdx and a corresponding step distanceIdx are obtained by looking up a table according to a partitioning mode index merge_gpm_partition_idx selected by the current block.

In some embodiments, the prediction parameter includes a geometric partitioning mode parameter of the current block, which is used to locate a dividing line of the current block. Exemplarily, the geometric partitioning mode parameter at least includes size information and partitioning information of the current block, and the partitioning information includes an angle angleIdx and a step distanceIdx for locating the dividing line.

The obtaining a weight value of a pixel of the current block according to a candidate transition width parameter includes: determining, based on the geometric partitioning mode parameter, a distance parameter of the pixel of the current block to a dividing line of the current block; and determining the weight value of the pixel of the current block based on the distance parameter and the candidate transition width parameter.

In a hybrid GPM weighted prediction calculation process, in the current block, predicted values of pixels that are relatively far from the dividing line are predicted values obtained in the respective two parts, while predicted values of pixels near the dividing line are obtained by performing hybrid weighted prediction on the predicted values in the two parts according to specific weight values, where the weight values are related to distances between the pixels and the dividing line. That is, a weight of each pixel in the current block is obtained through calculation according to a distance between the respective pixel and the dividing line. In this embodiment of this application, a relationship between a distance and a weight value is a linear relationship.

In some embodiments, the obtaining a weight value of a pixel of the current block according to a candidate transition width parameter includes: when the candidate transition width parameter represents that a transition width is a non-zero pixel width, adding the distance parameter and a half of the transition width, to obtain a translated distance parameter; dividing the translated distance parameter by a ratio of the transition width to a maximum weight value, to obtain a first intermediate weight value; and when the first intermediate weight value is less than or equal to a minimum weight value, determining the minimum weight value as the weight value of the pixel of the current block; or when the first intermediate weight value is greater than or equal to the maximum weight value, determining the maximum weight value as the weight value of the pixel of the current block; or when the first intermediate weight value is greater than the minimum weight value and less than the maximum weight value, determining the first intermediate weight value as the weight value of the pixel of the current block.

Exemplarily, the size of the current block is W×H. First, a distance parameter (weightIdx) of a pixel in the current block to the dividing line of the current block is calculated, and then the distance parameter is translated upwards by a half of a transition width, to obtain a translated distance parameter (weightIdxL). Finally, within the transition width, the translated distance parameter is divided by a ratio of the transition width to a maximum weight, to obtain a first intermediate weight value. Then, the first intermediate weight value is clamped within a weight range, to obtain a weight value (wValue) of the pixel in the current block.

$$weightIdx = ( ( ( xL + offsetX ) << 1 ) + 1 ) * disLut [ displacementX ] + ( ( ( yL + offsetY ) << 1 ) + 1 ) * disLut [ displacementY ] \qquad ( 1 )$$

$$weightIdxL = partFlip ? ( 1 □ ( 3 + weightTransitionWidthIdx ) + weightIdx ) ( 1 □ ( 3 + weightTransitionWidthIdx ) - weightIdx ) \qquad ( 2 )$$

$$\begin{matrix}wValue = Clip 3 ( \text{} \begin{matrix}0 , & wMax , ( weightIdxL + ( 1 □ ( weightTransitionWidthIdx - {log}_{2} wMax + 3 ) ) ) \\ □ & ( weightTransitionWidthIdx - {log}_{2} wMax + 3 + 1 )\end{matrix} ) & ( 3 )\end{matrix}$$

(xL, yL) are coordinates of the pixel of the current block, offsetX and offsetY are offset values of the current block, weightIdxL is the translated distance parameter, weightTransitionWidthIdx is a transition width parameter, weightTransitionWidthIdx is a logarithm of the transition width with a base of 2, 1<<(3+weightTransitionWidthIdx) indicates a half of the transition width, and >>(weightTransitionWidthIdx−log₂wMax+3+1) indicates being divided by the ratio of the transition width to the maximum weight value.

In some embodiments, the determining the weight value of the pixel of the current block based on the distance parameter and the candidate transition width parameter includes: when the candidate transition width parameter represents that a transition width is a non-zero pixel width, dividing the distance parameter by a ratio of the transition width to a maximum weight value, to obtain a scaled distance parameter; adding the scaled distance parameter and a half of the maximum weight value, to obtain a second intermediate weight value; and when the second intermediate weight value is less than or equal to a minimum weight value, determining the minimum weight value as the weight value of the pixel of the current block; or when the second intermediate weight value is greater than or equal to the maximum weight value, determining the maximum weight value as the weight value of the pixel of the current block; or when the second intermediate weight value is greater than the minimum weight value and less than the maximum weight value, determining the second intermediate weight value as a weight value for a second pixel.

Correspondingly, the foregoing calculation formula for calculating the weight value may be changed to:

$$weightIdxS = ( weightIdx + 1 □ ( weightTransitionWidthIdx - {log}_{2} wMax + 3 ) ) \text{} □ ( \text{} weightTransitionWidthIdx - {log}_{2} wMax + 3 + 1 ) \qquad ( 2 )$$

$$wValue = Clip 3 ( 0 , wMax ( partFlip ? ( weightIdxS + wMax □ 1 ) : ( weightIdxS - wMax □ 1 ) ) ) \qquad ( 3 )$$

weightIdxS is the scaled distance parameter, □ (weightTransitionWidthIdx−log₂wMax+3+1) indicates being divided by the ratio of the transition width to the maximum weight value, and wMax□ 1 indicates a half of the maximum weight value.

In some embodiments, the determining the weight value for the pixel of the current block based on the distance parameter and the candidate transition width parameter further includes: when the candidate transition width parameter represents that the transition width is a pixel width of 0, when the distance parameter is greater than 0, determining the maximum weight value as the weight value for the pixel of the current block; or when the distance parameter is less than or equal to 0, determining the minimum weight value as the weight value for the pixel of the current block.

When the transition width is a pixel width of 0, it may be understood that the weight matrix of the current block has no transition width. A predicted value of a pixel in the current block is a predicted value of a first part or a predicted value of a second part. A weight value is not controlled by the transition width parameter, and may be determined based on whether a distance between a pixel and the dividing line is positive or negative.

$$wValue = \{ \begin{matrix}wMax , & weightIdx > 0 \\ wMin , & weightIdx \leq 0\end{matrix} \qquad ( 4 )$$

Exemplarily, when weightTransitionWidthIdx=0, the transition width is 1; when weightTransitionWidthIdx=1, the transition width is 2; when weightTransitionWidthIdx=2, the transition width is 4; when weightTransitionWidthIdx=3, the transition width is 8. When weightTransitionWidthIdx=2, the transition width is 4, which corresponds to a case specified in the H.266 or VVC standard. In some embodiments, weightTransitionWidthIdx=−1 may be defined to indicate that the transition width is 0.

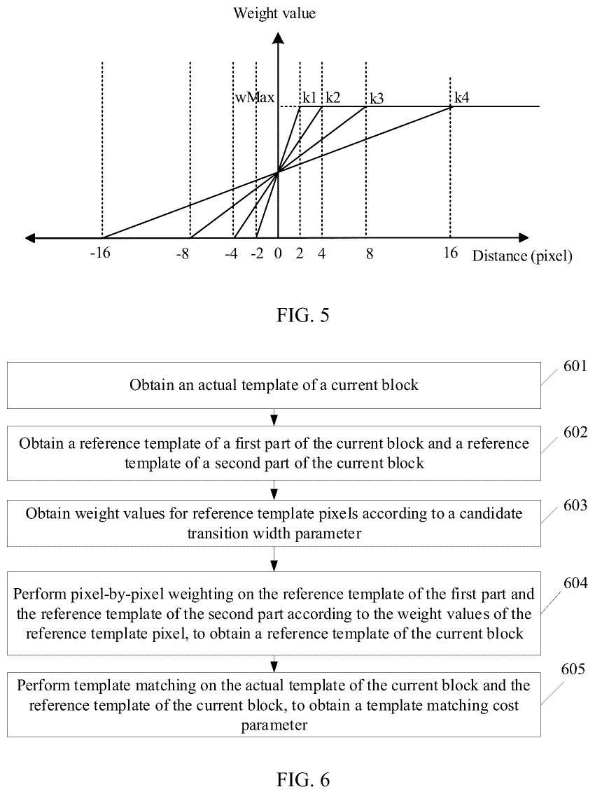

It may be understood that, to visualize the transition width, a control parameter weightTransitionWidthIdx is introduced in this embodiment of this application. weightIdx represents the distance between the pixel in the current block and the dividing line, and weightTransitionWidthIdx may control a change rate (that is, a slope k) of the weight wValue with weightIdx. FIG. 5 is a schematic diagram of a correspondence between a distance from a pixel to a dividing line and a weight value according to an embodiment of this application. As shown in FIG. 5, a horizontal coordinate indicates a distance measured in a unit of pixel, a vertical coordinate indicates a weight value, and weightTransitionWidthIdx affects a slope of a straight line within a transition width range. A smaller value of weightTransitionWidthIdx indicates a greater slope and a faster change of the weight w Value with weightIdx, that is, fewer pixels are required in a transition from a maximum value to a minimum value. This is represented intuitively as a smaller “width” of an area with non-maximum values and non-zero values near the “dividing line” in a weighting matrix (also referred to as a “weight matrix”). A larger value of weightTransitionWidthIdx indicates a smaller slope and a slower change of the weight wValue with weightIdx, that is, more pixels are required in a transition from a maximum value to a minimum value. This is represented intuitively as a greater “width” of an area with non-maximum values and non-zero values near the “dividing line” in a weighting matrix. The transition width may be 0, 1, 2, 4, 8, 16, or 32. When the transition width is 0, it indicates a sudden change between a maximum weight value and a minimum weight value. When the transition width is not 0, it needs to be ensured that a weight value for a pixel on the dividing line is a half of a maximum weight value (wMax). A farther distance between a pixel and the dividing line indicates a larger or smaller weight value, that is, in the current block, predicted values of pixels that are relatively far from the dividing line are predicted values obtained in the respective two parts, and a predicted value of a pixel near the dividing line (that is, within the transition width range) is obtained by performing hybrid weighted predication on the predicted values in the two parts according to an actual weight value, and the weight value is related to the distance between the pixel and the dividing line.

In actual application, the correspondence between a distance and a weight value may be obtained by rotating, translating and clamping a straight line y=x. Exemplarily, the straight line is first translated and then rotated, to obtain y=(x+width/2)k, or the straight line is first rotated and then translated, to obtain y=kx+(wMax−wMin)/2, where k is a slope, which controls a change rate of a weight value wValue with a distance, “width” is a transition width, and (wMax−wMin) is a weight range. In actual application, wMin is generally set to 0. In this case, the weight range is wMax.

Step 402: Perform pixel-by-pixel weighting on a first predicted value and a second predicted value of the current block according to the weight values of the pixels of the current block, to obtain a predicted value of the current block.

In a hybrid video encoding framework, encoding technologies such as prediction, transformation, and quantization are generally implemented in the unit of only square or rectangular block. However, in practice, an edge of a moving object may be not in a horizontal or vertical direction. In addition, motion vectors on two sides of the moving edge are often different, and a dividing line may not be accurately drawn onto an edge of the object. In this case, motion prediction and compensation performed based on an entire block in an encoding process tends to generate a relatively large prediction error, thereby causing limited encoding efficiency. Geometric partitioning mode (Geometric Partitioning Mode, GPM) allows partitioning of a coding block into two non-rectangular parts. Unidirectional prediction is separately performed on the two parts, and then weighted fusion is performed, to obtain a final predicted value.

That is, the first predicted value is a unidirectional predicted value of the first part (part0) of the current block, and the second predicted value is a unidirectional predicted value of the second part (part1) of the current block. To balance encoding performance and complexity of GPM, three encoding options, that is, GPM with MMVD, GPM with TM, and GPM with intra and inter, are introduced based on conventional GPM.

Exemplarily, the performing pixel-by-pixel weighting on a first predicted value and a second predicted value of the current block according to the weight value for the pixel of the current block, to obtain a predicted value of the current block includes: when the weight value is a minimum weight value, the predicted value of the current block being equal to the first predicted value; or when the weight value is a maximum weight value, the predicted value of the current block being equal to the second predicted value; or when the weight value is greater than the minimum weight value and less than the maximum weight value, performing a weighting operation by using the weight value as a weight value for the first predicted value and using a difference between the maximum weight value and the weight value as a weight value for the second predicted value, to obtain the predicted value of the current block.

Pixel-by-pixel weighting is performed on the unidirectional predicted values of the two parts, that is, part0 and part1, to obtain a final GPM predicted block. Specific weighted calculation is shown by the following formula:

$$WeightedSample [ x ] [ y ] = Clip 3 ( \begin{matrix}0 , & ( 1 □ BitDepth ) - 1 , \\ ( \begin{matrix}predSamplesLA [ x ] [ y ] * wValue + \\ predSamplesLB [ x ] [ y ] * ( wMax - wValue ) + offset 1\end{matrix} ) & □ shift 1\end{matrix} ) \qquad ( 5 )$$

offset1 is used for rounding, and shift1 is used to restore a predicted value on which weighted averaging has been performed to a same bit depth as an input video. offset1 and shift1 are calculated as follows:

$$shift 1 = Max ( 2 + {log}_{2} wMax , 14 + {log}_{2} wMax - BitDepth ) \qquad ( 5 )$$

$$offset 1 = 1 << ( shift 1 - 1 )$$

Exemplarily, according to a size of the current block W×H, partitioning information including an angle angleIdx and a step distanceIdx, and a transition width corresponding to a candidate transition width parameter, a weight matrix of W×H that has the same size as the current block is obtained, and the matrix is used to perform pixel-by-pixel weighting on the unidirectional predicted values of the two parts, that is, part0 and part1.

Step 403: Determine, based on a preset matching criterion, an error parameter of an original value of the current block and the predicted value of the current block.

Exemplarily, the matching criterion includes one of the following: a sum of absolute differences (SAD) criterion, a sum of squared difference (SSD) criterion, a mean absolute deviation (MAD) criterion, a mean squared difference (MSD) criterion, or a mean squared error (MSE) criterion. Correspondingly, the error parameter includes one of the following: a sum of absolute differences, a sum of squared differences, a mean absolute deviation, a mean squared difference, or a mean squared error.

Step 404: Sort the plurality of candidate transition width parameters according to the error parameter, and select a candidate transition width parameter corresponding to a least error parameter as the first transition width parameter.

Exemplarily, for each of weight matrices of different transition widths, an error parameter between a weighted predicted value and an original value of a current coding unit is calculated by using the matching criterion, an error list curBlockSadList of the current block is obtained by sorting the errors corresponding to the transition width parameters in ascending order, and a candidate transition width parameter corresponding to a least error parameter is selected as the first transition width parameter weightTransitionWidthIdx

Step 304: Determine, based on template matching, template matching cost parameters of the plurality of candidate transition width parameters.

FIG. 6 is a schematic flowchart of a template matching method according to an embodiment of this application. As shown in FIG. 6, the template matching method includes the following steps.

Step 601: Obtain an actual template of the current block.

In some embodiments, reconstruction information of a related area of the current block is obtained as the actual template of the current block. The actual template of the current block is a template actually used by the current block during prediction.

The related area may be understood as an area that is related to the current block, and an adjacent area is a reconstructed area that completes reconstruction. In some embodiments, the related area includes at least one of the following: an upper adjacent area, a left adjacent area, an upper left adjacent area, a lower left adjacent area, or an upper right adjacent area. In some embodiments, the related area may also be an area not adjacent to the current block.

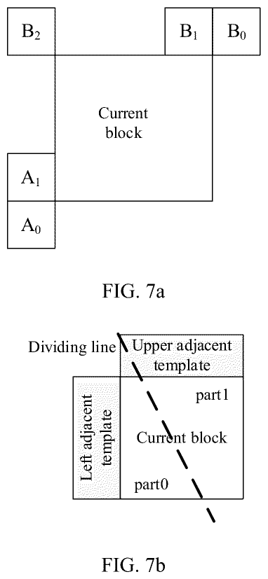

A size of the related area may be a preset size w×h. As shown in FIG. 7a, the related area may be a square block adjacent to the current block. As shown in FIG. 7b, the related area may be a rectangular block adjacent to the current block.

Exemplarily, as shown in FIG. 7b, the related area includes an upper adjacent area (CUAbove) and a left adjacent area (CULeft). If the upper adjacent area exists and the current block uses CUAbove in a corresponding partitioning mode, it is determined that the upper adjacent area is available, and TopTemplateAvailable is denoted as true; otherwise, TopTemplateAvailable is denoted as false.

If the left adjacent area exists and the current block uses CULeft in a corresponding partitioning mode, it is determined that the left adjacent area is available, and LeftTemplateAvailable is denoted as true; otherwise, LeftTemplateAvailable is denoted as false.

If TopTemplateAvailable=true, reconstruction information of four upper adjacent rows of the current block is obtained as an upper adjacent template of the current block, and is denoted as CurTopTemplate.

If LeftTemplateAvailable=true, a reconstruction sample of four left adjacent columns of the current block is obtained as a left adjacent template of the current block, and is denoted as CurLeftTemplate.

Step 602: Obtain a reference template of a first part of the current block and a reference template of a second part of the current block.

The reference template of the first part is a template of a reference block corresponding to the first part, and the reference template of the second part is a template of a reference block corresponding to the second part.

In some embodiments, the obtaining a reference template of a first part of the current block includes: when non-intra prediction is applied to the first part, obtaining first motion information of the first part; determining a first reference block of the first part based on the first motion information; obtaining reconstruction information of a related area of the first reference block as the reference template of the first part; and when intra prediction is applied to the first part, obtaining reconstruction information of a related area of the current block as the reference template of the first part.

The obtaining a reference template of a second part of the current block includes: when non-intra prediction is applied to the second part, obtaining second motion information of the second part; determining a second reference block of the second part based on the second motion information; obtaining reconstruction information of a related area of the second reference block as the reference template of the second part; and when intra prediction is applied to the second part, obtaining reconstruction information of a related area of the current block as the reference template of the second part.

Exemplarily, as shown in FIG. 7b, the related area includes an upper adjacent area (CUAbove) and a left adjacent area (CULeft).

If non-intra prediction is applied to the first part (part0), motion information of part0 is obtained, and a corresponding motion vector is denoted as MVₚₐᵣₜ₀.

If TopTemplateAvailable=true, a reference block of part0 is obtained by using an existing motion compensation technology, and reconstruction information of four upper adjacent rows of pixels of the reference block is obtained as an upper adjacent reference template of part0. Alternatively, MVₚₐᵣₜ₀ is shifted upwards by four pixels, to obtain MV_{part0_top} that points at an upper left corner of an upper adjacent template of part0, and reconstruction information of four upper adjacent rows of pixels of part0 is obtained by using an existing motion compensation technology and used as the upper adjacent reference template of part0. The upper adjacent reference template of part0 is denoted as Part0TopTemplate.

If LeftTemplateAvailable=true, a reference block of part0 is obtained by using an existing motion compensation technology, and reconstruction information of four left adjacent rows of pixels of the reference block is obtained as a left adjacent reference template of part0. Alternatively, MV part0 is shifted leftwards by four pixels, to obtain MV part0_left that points at an upper left corner of a left adjacent template of part0, and reconstruction information of four left adjacent columns of pixels of part0 is obtained by using an existing motion compensation technology and used as a left adjacent template of part0. The left adjacent template of part0 is denoted as Part0LeftTemplate.

If intra prediction is applied to part0, reconstruction sample information of four upper adjacent rows of pixels of the current block is used as an upper adjacent template of part0, and reconstruction information of four left adjacent columns of pixels of the current block is used as the left adjacent template of part0.

If non-intra prediction is applied to the second part (part1), motion information of part1 is obtained, and a corresponding motion vector is denoted as MVₚₐᵣₜ₁.

If TopTemplateAvailable=true, a reference block of part1 is obtained by using an existing motion compensation technology, and reconstruction information of four upper adjacent rows of pixels of the reference block is obtained as an upper adjacent reference template of part1. Alternatively, MVₚₐᵣₜ₁ is shifted upwards by four pixels, to obtain MV_{part1_top} that points at an upper left corner of an upper adjacent template of part1, and reconstruction information of four upper adjacent rows of pixels of part1 is obtained by using an existing motion compensation technology and used as an upper adjacent template of part1. The upper adjacent template of part1 is denoted as Part1TopTemplate.

If LeftTemplateAvailable=true, a reference block of part1 is obtained by using an existing motion compensation technology, and reconstruction information of four left adjacent rows of pixels of the reference block is obtained as a left adjacent reference template of part1. Alternatively, MVₚₐᵣₜ₁ is shifted leftwards by four pixels, to obtain MV_{part1_left} that points at an upper left corner of a left adjacent template of part1, and reconstruction information of four left adjacent columns of pixels of part1 is obtained by using an existing motion compensation technology and used as a left adjacent template of part1. The left adjacent template of part1 is denoted as Part1LeftTemplate.

If intra prediction is applied to part1, reconstruction information of four upper adjacent rows of pixels of the current block is used as an upper adjacent template of part1, and reconstruction information of four left adjacent columns of pixels of the current block is used as the left adjacent template of part1.

Step 603: Obtain weight values for reference template pixels according to a candidate transition width parameter.

In some embodiments, the prediction parameter includes a geometric partitioning mode parameter of the current block. Exemplarily, the geometric partitioning mode parameter at least includes size and partitioning information of the current block, and the partitioning information includes an angle angleIdx and a step distanceIdx for locating the dividing line.

The obtaining a weight values for reference template pixels according to a candidate transition width parameter includes: determining, based on the geometric partitioning mode parameter, distance parameters of the reference template pixels to an extension line of a dividing line of the current block; and determining the weight values for the reference template pixels based on the distance parameter and the candidate transition width parameter.

In a hybrid GPM weighted prediction calculation process, in the current block, predicted values of pixels that are relatively far from the dividing line are predicted values obtained in the respective two parts, while predicted values of pixels near the dividing line are obtained by performing hybrid weighted prediction on the predicted values in the two parts according to specific weight values, where the weight values are related to distances between the pixels and the dividing line. That is, a weight of each pixel in the current block is obtained through calculation according to a distance between the respective pixel and the dividing line. In this embodiment of this application, a relationship between a distance and a weight value is a linear relationship.

In some embodiments, the determining the weight values for the reference template pixels based on the distance parameter and the candidate transition width parameter includes: for each reference template pixel, when the candidate transition width parameter represents that a transition width is a non-zero pixel width, adding the distance parameter and a half of the transition width, to obtain a translated distance parameter; dividing the translated distance parameter by a ratio of the transition width to a maximum weight value, to obtain a first intermediate weight value; and when the first intermediate weight value is less than or equal to a minimum weight value, determining the minimum weight value as the weight value for the reference template pixel; or when the first intermediate weight value is greater than or equal to the maximum weight value, determining the maximum weight value as the weight value for the reference template pixel; or when the first intermediate weight value is greater than the minimum weight value and less than the maximum weight value, determining the first intermediate weight value as the weight value for the reference template pixel.

Exemplarily, the size of the current block is W×H, a size of the upper adjacent template is W×4, and a size of the left adjacent template is 4×H. When TopTemplateAvailable=true, weighting is performed on the upper adjacent template of the first part and the upper adjacent template of the second part by using weight matrices of different transition widths. A pixel whose weight is to be calculated is shifted upwards by four pixels. First, a distance parameter (weightIdx) of each pixel to an extension line of the dividing line is calculated, and then the distance parameter is translated upwards by a half of the transition width, to obtain a translated distance parameter (weightIdxL). Finally, within the transition width, the translated distance parameter is divided by a ratio of the transition width to a maximum weight, to obtain a first intermediate weight value. Then, the first intermediate weight value is clamped within a weight range, to obtain a weight value (wValue) of the pixel in the upper adjacent template.

$$weightIdx = \begin{matrix}( ( ( xL + offsetX - 4 ) << 1 ) + 1 ) * disLut [ displacementX ] + ( ( ( yL + offsetY ) << 1 ) + 1 ) * disLut [ displacementY ] & ( 6 )\end{matrix}$$

$$weightIdxL = \begin{matrix}partFlip ? ( 1 □ ( 3 + weightTransitionWidthIdx ) + weightIdx ) ( 1 □ ( 3 + weightTransitionWidthIdx ) - weightIdx ) & ( 7 )\end{matrix}$$

$$wValue = Clip 3 ( \text{} \begin{matrix}0 , & wMax , ( weightIdxL + ( 1 □ ( weightTransitionWidthIdx - {log}_{2} wMax + 3 ) ) ) \\ □ & ( weightTransitionWidthIdx - {log}_{2} wMax + 3 + 1 )\end{matrix} ) \qquad ( 8 )$$

(xL, yL) are coordinates of the pixel of the current block, offsetX and offsetY are offsets of the current block, weightIdxL is the translated distance parameter, weightTransitionWidthIdx is a transition width parameter, weightTransitionWidthIdx is a logarithm of the transition width with a base of 2, 1□ (3+weightTransitionWidthIdx) indicates a half of the transition width, and (weightTransitionWidthIdx−log₂wMax+3+1) indicates being divided by the ratio of the transition width to the maximum weight value.

If LeftTemplateAvailable=true, weighting is performed on the left adjacent template of the first part and the left adjacent template of the second part by using weight matrices of different transition widths. A pixel whose weight is to be calculated is shifted upwards by four pixels. First, a distance parameter (weightIdx) of each pixel to an extension line of the dividing line is calculated, and then the distance parameter is translated upwards by a half of a transition width, to obtain a translated distance parameter (weightIdxL). Finally, within the transition width, the translated distance parameter is divided by a ratio of the transition width to a maximum weight, to obtain a first intermediate weight value. Then, the first intermediate weight value is clamped within a weight range, to obtain a weight value (wValue) of a pixel in the left adjacent template.

$$weightIdx = \begin{matrix}( ( ( xL + offsetX ) << 1 ) + 1 ) * disLut [ displacementX ] + ( ( ( yL + offsetY - 4 ) << 1 ) + 1 ) * disLut [ displacementY ] & ( 9 )\end{matrix}$$

$$weightIdxL = partFlip ? ( 1 □ ( 3 + weightTransitionWidthIdx ) + weightIdx ) ( 1 □ ( 3 + weightTransitionWidthIdx ) - weightIdx ) \qquad ( 10 )$$

$$wValue = Clip 3 ( \text{} \begin{matrix}0 , & wMax , ( weightIdxL + ( 1 □ ( weightTransitionWidthIdx - {log}_{2} wMax + 3 ) ) ) \\ □ & ( weightTransitionWidthIdx - {log}_{2} wMax + 3 + 1 )\end{matrix} ) \qquad ( 11 )$$

In some embodiments, the determining the weight value for the reference template pixel based on the distance parameter and the candidate transition width parameter includes: when the candidate transition width parameter represents that a transition width is a non-zero pixel width, dividing the distance parameter by a ratio of the transition width to a maximum weight value, to obtain a scaled distance parameter; adding the scaled distance parameter and a half of the maximum weight value, to obtain a second intermediate weight value; and when the second intermediate weight value is less than or equal to a minimum weight value, determining the minimum weight value as the weight value for the reference template pixel; or when the second intermediate weight value is greater than or equal to the maximum weight value, determining the maximum weight value as the weight value for the reference template pixel; or when the second intermediate weight value is greater than the minimum weight value and less than the maximum weight value, determining the second intermediate weight value as the weight value for the reference template pixel.

Correspondingly, the foregoing calculation formulas (10) and (11) or formulas (13) and (14) for calculating the weight value may be changed to:

$$weightIdxS = ( weightIdx + 1 □ ( weightTransitionWidthIdx - {log}_{2} wMax + 3 ) ) \text{} □ ( \text{} weightTransitionWidthIdx - {log}_{2} wMax + 3 + 1 ) \qquad ( 12 )$$

$$wValue = Clip 3 ( 0 , wMax , ( partFlip ? ( weightIdxS + wMax □ 1 ) : ( weightIdxS - wMax □1 ) ) ) \qquad ( 13 )$$

weightIdxS is the scaled distance parameter, □ (weightTransitionWidthIdx−log_wMax+3+1) indicates being divided by the ratio of the transition width to the maximum weight value, and wMax□ 1 indicates a half of the maximum weight value.

In some embodiments, the determining the weight value for the reference template pixel based on the distance parameter and the candidate transition width parameter further includes: when the candidate transition width parameter represents that the transition width is a pixel width of 0, when the distance parameter is greater than 0, determining the maximum weight value as the weight value for the reference template pixel; or when the distance parameter is less than or equal to 0, determining the minimum weight value as the weight value for the reference template pixel.

When the transition width is the pixel width of 0, it may be understood that the weight matrix of the current block and the weight matrix of the reference template have no transition width. A pixel value of a pixel in the reference template is a pixel value of the reference template of the first part or a pixel value of the reference template of the second part. A weight value is not controlled by a transition width parameter, and a weight value may be determined based on whether a distance between a pixel and the extension line of the dividing line is positive or negative.

$$wValue = \{ \begin{matrix}wMax , & weightIdx > 0 \\ wMin , & weightIdx \leq 0\end{matrix} \qquad ( 14 )$$

Exemplarily, when weightTransitionWidthIdx=0, the transition width is 1; when weightTransitionWidthIdx=1, the transition width is 2; when weightTransitionWidthIdx=2, the transition width is 4; when weightTransitionWidthIdx=3, the transition width is 8. When weightTransitionWidthIdx=2, the transition width is 4, which corresponds to a case specified in the H.266 or VVC standard. In some embodiments, weightTransitionWidthIdx=−1 may be defined to indicate that the transition width is 0.

It may be understood that, to visualize the transition width, a control parameter weightTransitionWidthIdx is introduced in this embodiment of this application. weightIdx represents the distance between a pixel in the current block and the dividing line, and weightTransitionWidthIdx may control a change rate of the weight wValue with weightIdx. FIG. 5 is a schematic diagram of a correspondence between a distance from a pixel in a current block to a dividing line and a weight value according to an embodiment of this application. As shown in FIG. 5, a horizontal coordinate indicates a distance measured in a unit of pixel, and a vertical coordinate indicates a weight value. A smaller value of weightTransitionWidthIdx indicates a faster change of the weight wValue with weightIdx, that is, fewer pixels are required in a transition from a maximum value to a minimum value. This is represented visually as that a smaller “width” of an area with non-maximum values and non-zero values near the “dividing line” in a weighting matrix. The transition width may be 0, 1, 2, 4, 8, 16, or 32. When the transition width is 0, it indicates a sudden change between a maximum weight value and a minimum weight value. When the transition width is not 0, it needs to be ensured that a weight value for a pixel on the dividing line is a half of a maximum weight value (wMax). A farther distance between a pixel and the dividing line indicates a larger or smaller weight value, that is, in the current block, predicted values of pixels far from the dividing line are predicted values obtained in the respective two parts, and a predicted value of a pixel near the dividing line (that is, within the transition width range) is obtained by performing hybrid weighted predication on the predicted values in the two parts according to an actual weight value, and the weight value is related to the distance between the pixel and the dividing line.

In actual application, the correspondence between a distance and a weight value may be obtained by rotating, translating and clamping a straight line y=x. Exemplarily, the straight line is first translated and then rotated, to obtain y=(x+width/2)k, or the straight line is first rotated and then translated, to obtain y=kx+(wMax−wMin)/2, where k is a slope, which controls a change of a weight value wValue with a distance, width is a transition width, and (wMax−wMin) is a weight range. In actual application, wMin is generally set to 0. In this case, the weight range is wMax.

Step 604: Perform pixel-by-pixel weighting on the reference template of the first part and the reference template of the second part according to the weight values of the reference template pixels, to obtain a reference template of the current block.

Herein, the reference template of the first part and the reference template of the second part refer to reference templates of a same related area. For example, pixel-by-pixel weighting is performed on the upper adjacent reference template of the first part and the upper adjacent reference template of the second part, to obtain the upper adjacent reference template of the current block, and pixel-by-pixel weighting is performed on the left adjacent reference template of the first part and the left adjacent reference template of the second part, to obtain the left adjacent reference template of the current block. The same applies to other adjacent reference templates.

Exemplarily, the performing pixel-by-pixel weighting on the reference template of the first part and the reference template of the second part according to the weight values of the reference template pixels, to obtain a reference template of the current block includes: for each reference template pixel, when the weight value is a minimum weight value, a reference value of the reference template being equal to a first reference value; or when the weight value is a maximum weight value, a reference value of the reference template being equal to a second reference value; or when the weight value is greater than the minimum weight value and less than the maximum weight value, performing a weighting operation by using the weight value as a weight value for the first reference value and using a difference between the maximum weight value and the weight value as a weight value for the second reference value, to obtain a reference value of the reference template. The first reference value is a pixel value of the reference template of the first part, and the second reference value is a pixel value of the reference template of the second part. Specifically, the upper adjacent reference template of the current block is denoted as Re fTopTemplate, and is specifically obtained by using the following formula.

$$RefTopTemplate [ x ] [ y ] = Clip 3 ( 0 , ( 1 << BitDepth ) - 1 , ( Part 0 TopTemplate [ x ] [ y ] * wValue + Part 1 TopTemplate [ x ] [ y ] * ( wMax - wValue ) + offset 1 ) >> shift 1 ) \qquad ( 15 )$$

The left adjacent reference template of the current block is denoted as RefLeftTemplate, and is specifically obtained by using the following formula.

$$RefLeftTemplate [ x ] [ y ] = Clip 3 ( 0 , ( 1 << BitDepth ) - 1 , ( Part 0 LeftTemplate [ x ] [ y ] * wValue + Part 1 LeftTemplate [ x ] [ y ] * ( wMax - wValue ) + offset 1 ) >> shift 1 ) \qquad ( 16 )$$

Reference templates obtained by using different values of weightTransitionWidthIdx are denoted as follows:
Re fTopTemplate_{weightTransitionWidthIdx=1}, Re fLeftTemplate_{weightTransitionWidthIdx=1}
Re fTopTemplate_{weightTransitionWidthIdx=2}, Re fLeftTemplate_{weightTransitionWidthIdx=2}
Re fTopTemplate_{weightTransitionWidthIdx=3}, Re fLeftTemplate_{weightTransitionWidthIdx=3}

Exemplarily, according to a size of the current block W×H, partitioning information including an angle angleIdx and a step distanceIdx, and a transition width corresponding to a candidate transition width parameter, a weight matrix W×H that has the same size as the current block is obtained. To obtain a weight matrix of a template, the original weight matrix W×H is extended upwards and leftwards by four pixels, to obtain a weight matrix with a size of (W+4)×(H+4). Accordingly, offsetX′ and offsetY′ corresponding to the template are used to obtain a template weight matrix with a size of W×4 (the upper template) that corresponds to the upper adjacent template and/or a template weight matrix with a size of 4×H (the left template) that corresponds to the left adjacent template of the current block.

Vividly, the weight matrix of the current block is a weight matrix that has a corresponding size of W×H and is “matted out” from the weight matrix with the size of (W+4)×(H+4) by using offsetX and offsetY corresponding to the current block, and the weight matrix of the template is a template weighting matrix that has a corresponding size of W×4 (the upper template) and/or 4×H (the left template) and is “matted out” from the weight matrix with the size of (W+4)×(H+4) by using offsetX′ and offsetY′ corresponding to the template. A relationship between the weighting matrix used by the template and the weighting matrix of the current block is as follows: locations of corresponding dividing lines are the same, that is, a dividing line corresponding to the weighting matrix for the template is an extension of the dividing line of the current block.

Step 605: Perform template matching on the actual template of the current block and the reference template of the current block, to obtain a template matching cost parameter.

The template matching cost parameter of an actual template and a reference template of a same related area of the current block is calculated based on a preset matching criterion. Exemplarily, the matching criterion includes one of the following: a sum of absolute differences (SAD) criterion, a sum of squared difference (SSD) criterion, a mean absolute deviation (MAD) criterion, a mean squared difference (MSD) criterion, or a mean squared error (MSE) criterion. Correspondingly, the template matching cost parameter include one of the following: a sum of absolute differences, a sum of squared differences, a mean absolute deviation, a mean squared difference, or a mean squared error.

Exemplarily, the SAD criterion is used, in which SADs of templates of respective related areas are calculated, and then the SADs of the templates of the respective related areas are added up, to obtain an SAD corresponding to a candidate transition width parameter.

When TopTemplateAvailable=true, an SAD between the upper adjacent template CurTopTemplate and the upper adjacent reference template Re fTopTemplate of the current block is calculated and denoted as SAD_{Top}.

When LeftTemplateAvailable=true, an SAD between the left adjacent template CurLeftTemplate and the left adjacent reference template Re fLeftTemplate of the current block is calculated and denoted as SAD_{Left}.

SAD_{Top} and SAD_{Left} are added, to obtain the SAD corresponding to the candidate transition width parameter.

Step 305: Sort the plurality of candidate transition width parameters according to the template matching cost parameters, to obtain index parameters of the plurality of candidate transition width parameters.

Exemplarily, the plurality of candidate transition width parameters are sorted according to the template matching cost parameters, and a sorting sequence number is used as an index parameter. For example, the SADs of all the candidate transition width parameters are sorted in ascending order, to obtain a list tmSadList of costs of reordered candidate transition width parameters. A transition width parameter ranked the first in tmSadList has a smallest template matching cost, a transition width parameter ranked later has a larger template matching cost, and a value of an index parameter (index) in tmSadList is 0, 1, 2, 3, or the like.

Step 306: Determine an index parameter of the first transition width parameter from the index parameters of the plurality of candidate transition width parameters.

Exemplarily, the first transition width parameter weightTransitionWidthIdx is determined from the error list curBlockSadList of the current block, and an index parameter h of weightTransitionWidthIdx in the cost list tmSadList of the foregoing candidate transition width parameters is determined.

$$weightTransitionWidthIdx = curBlockSadList [ 0 ] \qquad ( 17 )$$

$$tmSadList [ h ] = weightTransitionWidthIdx \qquad ( 18 )$$

Step 307: Encode the index parameter of the first transition width parameter, to obtain a bitstream.

Exemplarily, in some embodiments, the index parameter of the first transition width parameter includes a first index parameter of a transition width group to which the first transition width parameter belongs and a second index parameter of the first transition width parameter in the transition width group to which the first transition width parameter belongs.

Exemplarily, in some embodiments, Golmb-Rice coding is used to encode index parameters in groups. First, a grouping parameter divisor is set to indicate a quantity of index parameters in each group. For example, divisor=1 indicates that there is one index parameter in each group, divisor=2 indicates that there are two index parameters in each group, divisor=4 indicates that there are four index parameters in each group, and divisor=8 indicates that there are eight index parameters in each group. When the quantity of the candidate transition width parameters is relatively small, the index parameter may be encoded by the Golmb-Rice with divisor=1. When the quantity of the candidate transition width parameters is relatively large, the index parameter may be encoded by the Golmb-Rice with divisor being greater than 1, which can reduce a bit rate.

For example, divisor=2, and the index parameter h is divided into two parts for encoding. One part is a group number Prefix (the first index parameter) of a group, and the other part is an offset Suffix (the second index parameter) in the group.

$$Prefix = h / divisor \qquad ( 19 )$$

$$Suffix = h \& ( divisor - 1 ) \qquad ( 20 )$$

A context model is used to perform unary encoding on the group number Prefix, a lower binary bit of a reminder Suffix is used as a code word of Suffix and truncated binary encoding is performed on the code word. Table 1 below provides code words of Prefix and Suffix and their corresponding CodeNum in Golmb-Rice.

TABLE 1
Golmb-Rice code words and corresponding CodeNum

| Code word of a prefix | Code word of a suffix | CodeNum |
|---|---|---|
| 011 | 0 | 0 |
| 011 | 1 | 1 |
| 101 | 0 | 2 |
| 101 | 1 | 3 |
| 110 | 0 | 4 |
| 110 | 1 | 5 |
| 111 | 0 | 6 |
| 111 | 1 | 7 |

It should be noted that an encoding manner of an index parameter is not limited to Golmb-Rice coding, and Exponential-Golmb coding may be used.

Exemplarily, in some embodiments, the index parameter of the first transition width parameter is used to index some candidate transition width parameters whose template matching cost parameters are ranked in top N, and Nis a positive integer. It may be understood that, when the quantity of the candidate transition width parameters is relatively large, after the template cost parameters are sorted in ascending order, because there is a high probability that the first transition width parameter is ranked in top N, the first N candidate transition width parameters are marked as usable transition width parameters, and only one of the first N index parameters is encoded. In this way, a relatively small quantity of bits may be used to index the first transition width parameter from a large quantity of candidate transition width parameters, thereby reducing a bit rate.

In this embodiment of this application, the weight range also affects prediction precision. A larger weight range indicates higher prediction precision, and a smaller weight range indicates lower prediction precision. In actual application, the minimum weight value is generally set to 0. Therefore, the maximum weight value may be pre-configured, or the maximum weight value may be flexibly configured according to an actual prediction precision requirement.

Exemplarily, in some embodiments, the method further includes: determining the maximum weight value based on the first transition width parameter.

Exemplarily, in some embodiments, the determining the maximum weight value based on the first transition width parameter includes: determining, based on a preset mapping relationship between a transition width parameter and a maximum weight value, the maximum weight value corresponding to the first transition width parameter. For example, when a transition width is 2, a weight range is (0,4); when a transition pixel width is 4, a weight range is (0,8); when a transition pixel width is 8, a weight range is (0,16).

Exemplarily, in some embodiments, the method further includes: determining, based on a second syntax element, whether to determine the first transition width parameter based on template matching. Exemplarily, in some embodiments, the second syntax element is comprised in a sequence parameter set, a picture parameter set, a picture header data unit, a slice header data unit, or a current block data unit.

By using the foregoing technical solutions, an encoding end determines a first transition width parameter from a plurality of candidate transition width parameters, sorts the plurality of candidate transition width parameters through template matching, determines an index parameter of the first transition width parameter from a sorting result, and encodes the index parameter. Consequently, a decoding end also sorts the plurality of candidate transition width parameters through template matching, determines, based on the index parameter, the first transition width parameter from a sorting result, so as to select an optimal transition width for a current block, to determine an optimal weight matrix of the current block. Compared with a solution of using a fixed transition width, the foregoing technical solutions can improve prediction accuracy of weighted prediction in GPM.

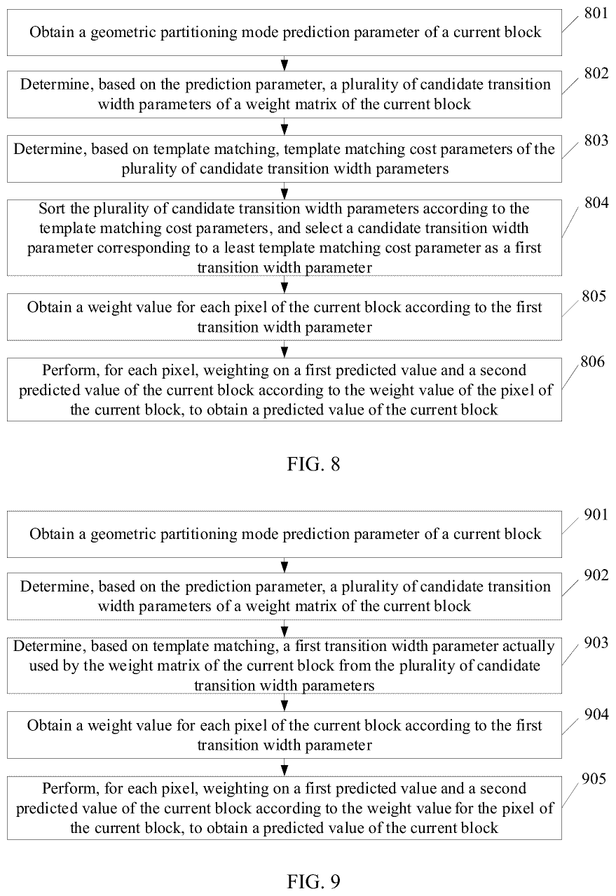

An embodiment of this application further provides another encoding method. FIG. 8 is a second schematic flowchart of an encoding method according to an embodiment of this application. As shown in FIG. 8, the method includes the following steps.

Step 801: Obtain a geometric partitioning mode prediction parameter of a current block.

Step 802: Determine, based on the prediction parameter, a plurality of candidate transition width parameters of a weight matrix of the current block.

Step 803: Determine, based on template matching, template matching cost parameters of the plurality of candidate transition width parameters.

Step 804: Sort the plurality of candidate transition width parameters according to the template matching cost parameters, and select a candidate transition width parameter corresponding to a least template matching cost parameter as the first transition width parameter.

That is, the different candidate transition width parameters are sorted by using the template matching cost parameters. In this case, a least cost parameter value is ranked the first, and the candidate transition width parameter corresponding to the least template matching cost parameter may be selected as the first transition width parameter actually used by the current block. In this method, a transition width parameter does not need to be transmitted in a bitstream. In this case, the transition width parameter corresponding to the least template matching cost parameter is the same as a transition width parameter of the current block.

Step 805: Obtain a weight value for a pixel of the current block according to the first transition width parameter.

Step 806: Perform weighting on a first predicted value and a second predicted value of the current block according to the weight value for the pixel of the current block, to obtain a predicted value of the current block.

By using the foregoing encoding method, a plurality of candidate transition width parameters are sorted according to template matching, and a candidate transition width parameter corresponding to the least template matching cost parameter is obtained from a sorting result and used as the first transition width parameter, to determine an optimal weight matrix of a current block. Compared with a solution of using a fixed transition width, this method can improve prediction accuracy of weighted prediction in GPM.

An embodiment of this application further provides a decoding method. FIG. 9 is a first schematic flowchart of a decoding method according to an embodiment of this application. As shown in FIG. 9, the method includes the following steps.

Step 901: Obtain a geometric partitioning mode prediction parameter of a current block.

Step 902: Determine, based on the prediction parameter, a plurality of candidate transition width parameters of a weight matrix of the current block.

It should be noted that the prediction parameter at least includes a parameter used to indicate a selection range of the candidate transition width parameters.

A transition width parameter (weightTransitionWidthIdx) is a parameter that represents a transition width (weightTransitionWidth) of a weight matrix, where the transition width represents, in a unit of pixel, a transition pixel width of the weight matrix at a dividing line. The transition width parameter may be the transition width or may be a control variable of the transition width. In some embodiments, the selection range of the transition width may include a quantity of pixels that is a power of 2, for example, 1, 2, 4, 8, 16, 32, or 64. Exemplarily, a selection range of the transition width is 2, 4, and 8, or the selection range of the transition width is 1, 2, 4, 8, 16, and 32. In some embodiments, an selection range of the transition width may include a quantity of pixels that is not a power of 2, for example, 0, 3, 5, or 7.

In some embodiments, the transition width parameter is a logarithm of the transition width with a base of 2. When the selection range of the transition width is 1, 2, 4, 8, 16, and 32, correspondingly, a selection range of the candidate transition width parameters is 0, 1, 2, 3, 4, and 5.

Exemplarily, in some embodiments, the prediction parameter includes a first syntax element used to indicate the plurality of candidate transition width parameters.

Exemplarily, the first syntax element is comprised in a sequence parameter set, a picture parameter set, a picture header data unit, a slice header data unit, or a current block data unit. That is, the selection range of the transition width of the weight matrix may be adjusted in high-level syntax such as a sequence parameter set (SPS) or a picture parameter set (SPS). Alternatively, the selection range of the transition width of the weight matrix is indicated in a picture header data unit (picture header, PH), a slice header data unit (slice header, SH), or a current block data unit (CU layer). For example, the selection range of the transition width of the weight matrix is controlled to range from 4 to 16.

Exemplarily, in some embodiments, the prediction parameter includes a size of the current block, a resolution of the current block, a quantization parameter of the current block, and a difference between motion vectors of two parts of the current block.

A larger size of the current block indicates a larger transition width, and a smaller size of the current block indicates a smaller transition width. A higher resolution of the current block indicates a larger transition width, and a lower resolution of the current block indicates a smaller transition width. A smaller quantization parameter of the current block indicates a larger transition width, and a larger size of the current block indicates a smaller transition width. A larger difference between motion vectors of the two parts indicates a larger transition width, and a smaller difference between motion vectors of the two parts indicates a smaller transition width.

In some embodiments, an upper limit and/or a lower limit of the selection range of the transition width may be determined based on these prediction parameters, that is, an upper limit and/or a lower limit of the selection range of the candidate transition width parameters are determined.

Step 903: Determine, based on template matching, a first transition width parameter actually used by the weight matrix of the current block from the plurality of candidate transition width parameters.

In some embodiments, the method further includes: decoding a bitstream, to determine an index parameter of the first transition width parameter. The determining, based on template matching, a first transition width parameter actually used by the weight matrix of the current block from the plurality of candidate transition width parameters includes: determining, based on template matching, template matching cost parameters of the plurality of candidate transition width parameters; sorting the plurality of candidate transition width parameters according to the template matching cost parameters, to obtain index parameters of the plurality of candidate transition width parameters; and determining, based on the index parameter of the first transition width parameter, the first transition width parameter from the plurality of candidate transition width parameters.

That is, an index parameter of a transition width parameter of the current block is determined by decoding a bitstream, and different candidate transition width parameters are sorted according to template matching cost parameters. In this way, index parameters corresponding to the different candidate transition width parameters are determined, so that the first transition width parameter actually used by the current block is determined. In this case, a transition width parameter corresponding to a least template matching cost parameter may be different from the first transition width parameter of the current block.

In some embodiments, the determining, based on template matching, a first transition width parameter actually used by the weight matrix of the current block from the plurality of candidate transition width parameters includes: determining, based on template matching, template matching cost parameters of the plurality of candidate transition width parameters; sorting the plurality of candidate transition width parameters according to the template matching cost parameters, and selecting a candidate transition width parameter corresponding to a least template matching cost parameter as the first transition width parameter.

That is, the different candidate transition width parameters are sorted according to the template matching cost parameters. In this case, a least cost parameter value is ranked the first, and the candidate transition width parameter corresponding to the least template matching cost parameter may be selected as the first transition width parameter actually used by the current block. In this case, a transition width parameter does not need to be transmitted in a bitstream. In this case, the transition width parameter corresponding to the least template matching cost parameter is the same as a transition width parameter of the current block.

Exemplarily, in some embodiments, the plurality of candidate transition width parameters are sorted according to the template matching cost parameters, to obtain a template matching cost list, a bitstream is decoded to obtain the index parameter of the first transition width parameter, and the template matching cost list is looked up according to the index parameter of the first transition width parameter, to determine the first transition width parameter. Alternatively, a transition width parameter ranked the first in the template matching cost list is directly determined as the first transition width parameter. An optimal transition width is selected for the current block from a plurality of candidate transition widths through template matching, to determine an optimal weight matrix of the current block. Compared with a solution of using a fixed transition width, this solution can improve prediction accuracy of weighted prediction in GPM.

Exemplarily, in some embodiments, the determining, based on template matching, template matching cost parameters of the plurality of candidate transition width parameters includes: obtaining an actual template of the current block; obtaining a reference template of a first part of the current block and a reference template of a second part of the current block; for a candidate transition width parameter among the candidate transition width parameters, obtaining weight values of reference template pixels according to the candidate transition width parameter; performing pixel-by-pixel weighting on the reference template of the first part and the reference template of the second part according to the weight values of reference template pixels, to obtain a reference template of the current block; and performing template matching on the actual template of the current block and the reference template of the current block, to obtain a template matching cost parameter.

Exemplarily, in some embodiments, the obtaining an actual template of the current block includes: obtaining reconstruction information of a related area of the current block as the actual template of the current block.

Exemplarily, in some embodiments, the obtaining a reference template of a first part of the current block includes: when non-intra prediction is applied to the first part, obtaining first motion information of the first part; determining a first reference block of the first part based on the first motion information; obtaining reconstruction information of a related area of the first reference block as the reference template of the first part; and when intra prediction is applied to the first part, obtaining reconstruction information of a related area of the current block as the reference template of the first part.

The obtaining a reference template of a second part of the current block includes: when non-intra prediction is applied to the second part, obtaining second motion information of the second part; determining a second reference block of the second part based on the second motion information; obtaining reconstruction information of a related area of the second reference block as the reference template of the second part; and when intra prediction is applied to the second part, obtaining reconstruction information of a related area of the current block as the reference template of the second part.

Exemplarily, in some embodiments, the related area includes at least one of the following: an upper adjacent area, a left adjacent area, an upper left adjacent area, a lower left adjacent area, or an upper right adjacent area.

Exemplarily, in some embodiments, location and size information of the related area may be preset, or may be configured by using a syntax element. For example, the related area includes an upper adjacent area and a left adjacent area, and may further include one or more of an upper left adjacent area, a lower left adjacent area, and an upper right adjacent area. A size of the current block is W×H, and a size of the related area is w×h, where w is equal to or not equal to h. In some embodiments, the related area includes an upper adjacent area with a size of W×4 and a left adjacent area with a size of 4×H. A quantity of rows or columns of the upper adjacent area or the left adjacent area is not limited to 4, and there may be more choices, such as 1, 2, 3, and 5.

Exemplarily, in some embodiments, the template matching cost parameters each include one of the following: a sum of absolute differences, a sum of squared differences, a mean absolute deviation, a mean squared difference, or a mean squared error.

For a more detailed template matching method, refer to step 601 to step 605 at an encoding end.

At a decoding end, a bitstream is decoded to determine the index parameter of the first transition width parameter. Exemplarily, in some embodiments, the index parameter of the first transition width parameter includes a first index parameter of a transition width group to which the first transition width parameter belongs and a second index parameter of the first transition width parameter in the transition width group to which the first transition width parameter belongs.

The first index parameter Prefix and the second index parameter are Suffix obtained through decoding. In this case, the first transition width parameter weightTransitionWidthIdx is obtained in the following manner:

$$merge\_gpm \_weightedmatrix \_idx [ x 0 ] [ y 0 ] = Prefix * divisor + Suffix \qquad ( 21 )$$

$$h = merge\_gpm \_weightedmatrix \_idx [ x 0 ] [ y 0 ] \qquad ( 22 )$$

$$weightTransitionWidthIdx = tmSadList [ h ] \qquad ( 23 )$$

h is an index of the weight matrix in a template matching cost list tmSadList, and weightTransitionWidthIdx is an optimal transition width parameter obtained through decoding, that is, the first transition width parameter.

Step 904: Obtain a weight value for a pixel of the current block according to the first transition width parameter.

Exemplarily, in some embodiments, the prediction parameter includes a geometric partitioning mode parameter of the current block, which is used to locate a dividing line of the current block. Exemplarily, the geometric partitioning mode parameter at least includes size and partitioning information of the current block, and the partitioning information includes an angle angleIdx and a step distanceIdx for locating the dividing line.

The obtaining a weight value for a pixel of the current block according to the candidate transition width parameter includes: determining, based on the geometric partitioning mode parameter, a distance parameter of the pixel of the current block to a dividing line of the current block; and determining the weight value for the pixel of the current block based on the distance parameter and the first transition width parameter.

In some embodiments, the obtaining the weight value for the pixel of the current block according to the candidate transition width parameters includes: when the candidate transition width parameter represents that the transition width is a non-zero pixel width, adding the distance parameter and a half of the transition width, to obtain a translated distance parameter; dividing the translated distance parameter by a ratio of the transition width to a maximum weight value, to obtain a first intermediate weight value; and when the first intermediate weight value is less than or equal to a minimum weight value, determining the minimum weight value as the weight value for the pixel of the current block; or when the first intermediate weight value is greater than or equal to the maximum weight value, determining the maximum weight value as the weight value for the pixel of the current block; or when the first intermediate weight value is greater than the minimum weight value and less than the maximum weight value, determining the first intermediate weight value as the weight value for the pixel of the current block.

In some embodiments, the determining the weight value for the pixel of the current block based on the distance parameter and the candidate transition width parameters includes: when the candidate transition width parameter represents that the transition width is a non-zero pixel width, dividing the distance parameter by a ratio of the transition width to a maximum weight value, to obtain a scaled distance parameter; adding the scaled distance parameter and a half of the maximum weight value, to obtain a second intermediate weight value; and when the second intermediate weight value is less than or equal to a minimum weight value, determining the minimum weight value as the weight value for the pixel of the current block; or when the second intermediate weight value is greater than or equal to the maximum weight value, determining the maximum weight value as the weight value for the pixel of the current block; or when the second intermediate weight value is greater than the minimum weight value and less than the maximum weight value, determining the second intermediate weight value as a weight value for a second pixel.

In some embodiments, the determining the weight value for the pixel of the current block based on the distance parameter and the candidate transition width parameter further includes: when the candidate transition width parameter represents that the transition width is a pixel width of 0, when the distance parameter is greater than 0, determining the maximum weight value as the weight value for the pixel of the current block; or when the distance parameter is less than or equal to 0, determining the minimum weight value as the weight value for the pixel of the current block.

When the transition width is a pixel width of 0, it may be understood that the weight matrix of the current block has no transition width. A predicted value of a pixel in the current block is a predicted value in a first part or a predicted value in a second part. A weight value is not controlled by a transition width parameter, and a weight value may be determined based on whether a distance between a pixel and the dividing line is positive or negative.

Step 905: Perform weighting on a first predicted value and a second predicted value of the current block according to the weight value for the pixel of the current block, to obtain a predicted value of the current block.

In a hybrid video encoding framework, encoding technologies such as prediction, transformation, and quantization are generally implemented in the unit of only square or rectangular block. However, in practice, an edge of a moving object is not necessarily in a horizontal or vertical direction. In addition, motion vectors on two sides of a moving edge are often different, and a dividing line may not be accurately drawn onto an edge of the object. In this case, motion prediction and compensation performed based on an entire block in an encoding process tends to generate a relatively large prediction error, thereby causing limited encoding efficiency. Geometric partitioning mode (GPM) allows partitioning of a coding block into two non-rectangular parts. Unidirectional prediction is separately performed on the two parts, and then weighted fusion is performed, to obtain a final predicted value.

That is, the first predicted value is a unidirectional predicted value of the first part (part0) of the current block, and the second predicted value is a unidirectional predicted value of the second part (part1) of the current block. To balance encoding performance and complexity of GPM, three encoding choices, that is, GPM with MMVD, GPM with TM, and GPM with intra and inter, are introduced based on conventional GPM.

Exemplarily, the performing pixel-by-pixel weighting on a first predicted value and a second predicted value of the current block according to the weight value for the pixel of the current block, to obtain a predicted value of the current block includes: when the weight value is a minimum weight value, determining the predicted value of the current block as the first predicted value; or when the weight value is a maximum weight value, determining the predicted value of the current block as the second predicted value; or when the weight value is greater than the minimum weight value and less than the maximum weight value, performing a weighting operation by using the weight value as a weight value for the first predicted value and using a difference between the maximum weight value and the weight value as a weight value for the second predicted value, to obtain the predicted value of the current block.

Exemplarily, in some embodiments, the index parameter of the first transition width parameter is used to index some candidate transition width parameters whose template matching cost parameters are ranked in top N, where N is a positive integer. It may be understood that, when the quantity of the candidate transition width parameters is relatively large, after the template cost parameters are sorted in ascending order, because there is a high probability that the first transition width parameter is ranked among the top N, the first N candidate transition width parameters are marked as usable transition width parameters, and only one of the first N index parameters is encoded. In this way, a relatively small quantity of bits may be used to index the first transition width parameter from a large quantity of candidate transition width parameters, thereby reducing a bit rate.

In this embodiment of this application, a weight range also affects prediction precision. A larger weight range indicates higher prediction precision, and a smaller weight range indicates lower prediction precision. In actual application, a minimum weight value is generally set to 0. Therefore, the maximum weight value may be pre-configured, or the maximum weight value may be flexibly configured according to an actual prediction precision requirement.

Exemplarily, in some embodiments, the method further includes: determining the maximum weight value based on the first transition width parameter.

Exemplarily, in some embodiments, the determining the maximum weight value based on the first transition width parameter includes: determining, based on a preset mapping relationship between a transition width parameter and a maximum weight value, the maximum weight value corresponding to the first transition width parameter. For example, when a transition width is 2, a weight range is (0,4); when a transition pixel width is 4, a weight range is (0,8); when a transition pixel width is 8, a weight range is (0,16).

Exemplarily, in some embodiments, the method further includes: determining, based on a second syntax element, whether to determine the first transition width parameter based on template matching. Exemplarily, in some embodiments, the second syntax element is comprised in a sequence parameter set, a picture parameter set, a picture header data unit, a slice header data unit, or a current block data unit.

By using the foregoing technical solution, an encoding end sorts a plurality of candidate transition width parameters through template matching, and selects an optimal transition width parameter for a current block from a sorting result, to determine an optimal weight matrix of the current block. Compared with a solution in which a fixed transition width is used, this solution can improve prediction accuracy of weighted prediction in GPM. An optimal transition width may be selected for the current block, to determine an optimal weight matrix of the current block. Compared with a solution of using a fixed transition width, this solution can improve prediction accuracy of weighted prediction in GPM. Specifically, an index parameter of a first transition width parameter is obtained by decoding a bitstream, and the first transition width parameter is determined from a sorting result based on the index parameter. Alternatively, a candidate transition width parameter corresponding to a least template matching cost parameter is directly obtained from the sorting result as the first transition width parameter. Therefore, selection of a weight matrix is more accurate. Using Golmb-Rice to encode the index parameter may further reduce a bit rate.

The following further describes application of the coding methods provided in embodiments of this application by using examples. It should be noted that, in a hybrid video encoding framework, a geometric partitioning mode is included in the inter prediction unit 115 shown in FIG. 1 and the motion compensation unit 215 shown in FIG. 2.

In a hybrid video encoding framework, encoding technologies such as prediction, transformation, and quantization are generally implemented in the unit of only square or rectangular block. However, in practice, an edge of a moving object is not necessarily in a horizontal or vertical direction. In addition, motion vectors on two sides of a moving edge are often different, and a dividing line may not be accurately drawn onto an edge of the object. In this case, motion prediction and compensation performed based on an entire block in an encoding process tends to generate a relatively large prediction error, thereby causing limited encoding efficiency. Geometric partitioning mode (GPM) allows partitioning of a coding block into two non-rectangular parts. Unidirectional prediction is separately performed on the two parts, and then weighted fusion is performed, to obtain a final predicted value.

The GPM mode is introduced in H.266 or VVC, and this technology is also used in the ECM model established in exploring a next-generation video encoding standard. In addition, based on H.266 or VVC, an optional sub-coding mode is further added in ECM 4.0.

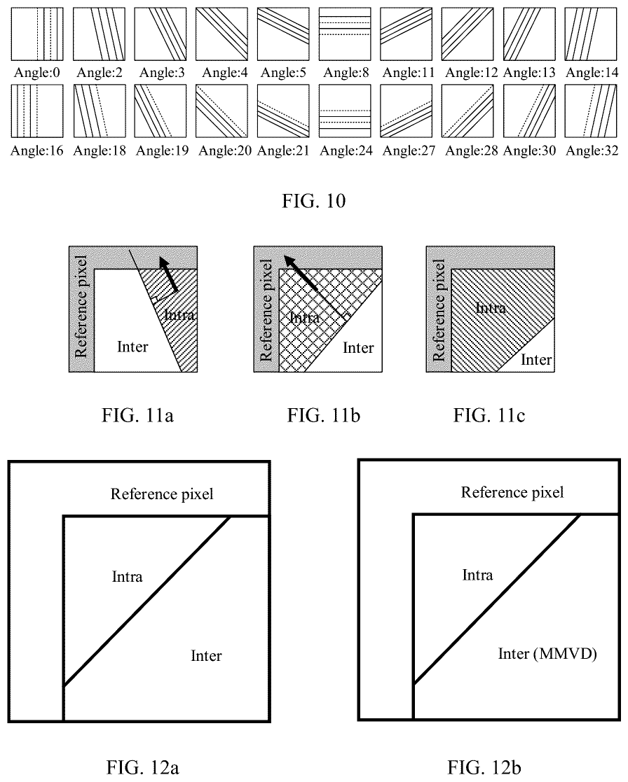

Currently, GPM includes a total of 64 types of partitioning manners. Specifically, as shown in FIG. 10, a total of 20 angles are included. Each angle corresponds to at most four offsets. Solid lines in FIG. 10 indicate corresponding partitioning manners. A geometric straight line in a current block is determined according to a selected angle and an offset parameter, to divide the current block into two parts. Unidirectional motion compensation is performed separately on each part, to obtain a unidirectional predicted value, and finally, weighted fusion is performed on the unidirectional predicted values of the two parts by using a weight matrix, to obtain a final GPM predicted value.

Conditions for using GPM are as follows:
1) A sequence parameter set (SPS) allows use of a GPM prediction manner;
2) A currently encoded image area belongs to a bi-predictive slice (B slice);
3) Block size constraints: Both a width and a height must be greater than or equal to 8 and less than 128, and both a width-to-height ratio and a height-to-width ratio of the current block must be less than 8; and
4) The current block does not apply any of Common fusion prediction (general merge), fusion subblock prediction (merge_subblock), affine prediction, or composed intra inter prediction (composed intra inter prediction, CIIP).

To balance encoding performance and complexity of GPM, three encoding choices, that is, GPM with MMVD, GPM with TM, and GPM with intra and inter, are introduced based on conventional GPM.

In GPM_MMVD, an MMVD technology is applied to the GPM mode. In the latest Beyond VVC version, that is, ECM 4.0, a procedure of the MMVD technology is basically as follows:
(1) First, unidirectional merge candidates in the common GPM mode are repeatedly used, and these candidates are used as initial motion vectors; and
(2) One offset is applied to the initial MVs. The offset is selected only from a set of combinations of several fixed optional amplitudes and directions (the offset is identified by an amplitude index and a direction symbol in a bitstream), to obtain shifted motion vectors for motion compensation.

In a GPM_TM technology, template matching is used for the GPM mode, to refine a motion vector of a part by minimizing a difference between a template of a current coding unit or block and a template of a corresponding coding unit or block in a reference image.

In a GPM with intra and inter technology, an intra mode and an inter mode are respectively used in two GPM parts, to obtain predicted values of the parts. Finally, weighted fusion is performed on the predicted values of the two parts.

Currently, only one of GPM-MMVD and GPM-TM is enabled for a GPM CU. GPM-MMVD and GPM-TM are in a competitive relationship. When GPM-MMVD flags gpm_mmvd_flag [x0][y0] of two parts are both equal to false (that is, the GPM-MMVD mode is disabled for two GPM parts), a GPM-TM flag tmMergeFlag [x0][y0] is parsed, to indicate whether template matching is applied to the two GPM parts. When tmMergeFlag is true, motion vectors in both of the two parts are corrected in the GPM TM mode.

Table 2 shows syntax element parsing of four GPM modes.

TABLE 2
Syntax element parsing of four GPM modes

| | |
|---|---|
| if( gpm_flag[ x0 ][ y0 ] ) { | |
| gpm_mmvd_flag0[ x0 ][ y0 ] | ae(v) |
| if (gpm_mmvd_flag0[ x0 ][ y0 ]){ | |
| gpm_mmvd_distance_idx0[ x0 ][ y0 ] | ae(v) |
| gpm_mmvd_direction_idx0[ x0 ][ y0 ] | ae(v) |
| gpm_mmvd_idx0= gpm_mmvd_distance_idx0[ x0 ][ y0 ] * | |
| maxMMVDDir + gpm_mmvd_direction_idx0[ x0 ][ y0 ] | |
| } | |
| gpm_mmvd_flag1[ x0 ][ y0 ] | ae(v) |
| if (gpm_mmvd_flag1[ x0 ][ y0 ]){ | |
| gpm_mmvd_distance _idx1[ x0 ][ y0 ] | ae(v) |
| gpm_mmvd_direction _idx1[ x0 ][ y0 ] | ae(v) |
| gpm_mmvd_idx1= gpm_mmvd_distance_idx1[ x0 ][ y0 ] * | |
| maxMMVDDir + gpm_mmvd_direction_idx1[ x0 ][ y0 ] | |
| } | |
| if ( !gpm_mmvd_flag0[ x0 ][ y0 ] && !gpm_mmvd_flag1[ x0 ][ y0 ]){ | |
| tm_merge_flag[ x0 ][ y0 ] | ae(v) |
| if (tm_merge_flag[ x0 ][ y0 ]){ | |
| gpm_tm_flag0=true | |
| gpm_tm_flag1=true | |
| gpm_merge_idx( ) | |
| }else{ | |
| gpm_tm_flag0=false | |
| gpm_tm_flag1=false | |
| gpm_merge_idx( ) | |
| } | |
| } | |
| else if (gpm_mmvd_flag0[ x0 ][ y0 ] && gpm_mmvd | |
| _flag1 [ x0 ][ y0 ]){ | |
| if(gpm_mmvd_idx0[ x0 ][ y0 ] == gpm_mmvd_idx1[ x0 ][ y0 ]){ | |
| gpm_merge_idx( ) | |
| }else{ | |
| gpm_merge_idx1( ) | |
| } | |
| }else{ | |
| gpm_merge_idx 1( ) | |
| } | |
| } | |

Note: Both gpm_merge_idx( ) and gpm_merge_idx1( ) are used to parse a GPM partitioning manner and candidate indexes of two parts, but the second part has a different candidate parsing manner.

gpm_merge_idx( )

| | |
|---|---|
| merge_gpm_partition_idx[ x0 ][ y0 ] | ae(v) |
| merge_gpm_idx0[ x0 ][ y0 ]= | ae(v) |
| unary_max_eqprob(numCandminus2)+1 | |
| if(numCandminus2>0) | |
| merge_gpm_idx1[ x0 ][ y0 ]= | ae(v) |
| unary_max_eqprob(numCandminus2-1)+1 | |

gpm_merge_idx1( )

| | |
|---|---|
| merge_gpm_partition_idx[ x0 ][ y0 ] | ae(v) |
| merge_gpm_idx0[ x0 ][ y0 ] | ae(v) |
| =unary_max_eqprob(numCandminus2)+1 | |
| if(numCandminus2>0) | |
| merge_gpm_idx1[ x0 ][ y0 ]= | ae(v) |
| unary_max_eqprob(numCandminus2)+1 | |

(1) A unidirectional GPM candidate list is constructed. The unidirectional GPM candidate list is derived from a conventional merge list.

In a CU using GPM, each part uses only a unidirectional prediction mode, but each item in a merge list may be MV information of a bidirectional prediction. Therefore, unidirectional prediction MVs in the merge list need to be extracted for use by GPM. A maximum length of the GPM candidate list is specified by a syntax element MaxNumGpmMergeCand at an SPS layer. In implementation of ECM 4.0 to ECM 5.0, duplicate detection and de-duplication operations are performed in the each of following processes of adding a candidate item to a candidate list.

First, a parity check method is applied, in which X==(m&0x01), that is, a last bit of m is taken, where & is a bit AND operation, m represents an index of each candidate in the unidirectional GPM candidate list (m=0 . . . 9), X represents whether a prediction direction of a GPM candidate at a location m is forward or backward. In this way, it can be ensured that the GPM candidate at the location m preferentially uses MV information corresponding to a reference image in a reference list corresponding to X in a conventional merge list, and then is used for prediction of a GPM part, for example, an option corresponding to a “×” area in Table 3. If a corresponding MV is unusable (or the candidate in the conventional merge list at the location m may also be unidirectional), an opposite MV (an MV represented by a blank area corresponding to the “×” area) is used. In this case, X=1−X. Duplicate detection and de-duplication are performed on each of the candidate items in sequence, before the candidate items are filled in the GPM candidate list, that is, each item is compared with an existing item in the candidate list. An item whose reference image and MV value are both the same as those of an existing item is not filled in the candidate list, while an item whose reference image or MV value or both are different from those of an existing item is filled in the candidate list.

TABLE 3
GPM candidate list constructed after
the first time of parity clipping

| Merge_Cand_Idx | L0 | L1 |
|---|---|---|
| 0 | x | |
| 1 | | x |
| 2 | x | |
| 3 | | x |
| 4 | x | |

| | |
|---|---|
| . . . | . . . |

| | |
|---|---|
| 9 | x |

If a length of the unidirectional GPM candidate list filled by the foregoing process is less than MaxNumGpmMergeCand, a new candidate item is obtained in an opposite parity clipping sequence as shown in Table 4. Duplicate detection and de-duplication are performed on these candidate items based on the current GPM candidate list before they are filled in the GPM candidate list.

TABLE 4
GPM candidate list constructed after
the second time of parity clipping

| Merge_Cand_Idx | L0 | L1 |
|---|---|---|
| 0 | | x |
| 1 | x | |
| 2 | | x |
| 3 | x | |
| 4 | | x |

| | |
|---|---|
| . . . | . . . |

| | |
|---|---|
| 9 | x |

If a quantity of candidates in the GPM candidate lists is still less than MaxNumGpmMergeCand, a maximum of two average candidates are further added after duplicate detection based on the current GPM candidate list. The first two available L0 candidates in the GPM candidate list are averaged, to add one forward L0 candidate, and the first two available backward L1 candidates in the GPM candidate list are averaged to add one L1 candidate. If the length of the list still does not meet the condition, parity clipping is performed on bidirectional zero candidates to add unidirectional zero candidates in the list.

### 2. GPM Prediction Process

### 2.1 Acquisition of Unidirectional Predicted Values of Two Parts

### 2.1.1 Conventional GPM Mode

In the conventional GPM mode, motion vectors of two parts of a CU are directly derived from corresponding items in the previously constructed GPM candidate list.

merge_gpm_idx0[xCb][yCb] indicates an index, in a unidirectional merge list, of an MV of a part A that is actually entropy coded, and merge_gpm_idx1[xCb][yCb] indicates an index, in the merge list, of an MV of a part B that is actually entropy coded. It is assumed that m and n are respectively unidirectional merge indexes of the two parts.

The m^{th} candidate M is extracted from the merge list and used for MV construction of the part A, and a unidirectional candidate of the part A is obtained as shown by (27).

$$m = merge\_gpm \_idx 0 [ xCb ] [ yCb ] \\ M = mergeCandList [ m ] \qquad ( 24 )$$

The n^{th} candidate N is extracted from the merge list and used for MV construction of the part B. For a location of an MV of the second part in the merge list, since an item located in the front may be selected for the first part, an index of the second part needs to be reduced by 1 to perform entropy coding. Acquisition of a unidirectional candidate of the part B is shown by (28).

$$n = merge\_gpm \_idx 1 [ xCb ] [ yCb ] + ( ( merge\_gpm \_idx 1 [ xCb ] [ yCb ] > m ) ? 1 : 0 ) \\ N = mergeCandList [ n ] \qquad ( 25 )$$

X represents a prediction direction of a GPM motion vector candidate at a location m, X=0 represents that a motion vector candidate of a GPM part comes from a forward reference frame, and X=1 represents that a motion vector candidate of a GPM part comes from a backward reference frame. According to a rule of parity clipping, X=(m&0x01) If a corresponding MV is unusable, an opposite MV is used. In this case, X=1−X. mvA,mvB represents motion vectors of the two parts, refIdxA, refIdxB represents reference indexes of the two parts, and predListFlagA, predListFlagB represents the prediction list flags of two parts. The obtained motion vector information of the part A is shown in the following formula.

$$mvA [ 0 ] = mvLXM [ 0 ] \\ mvA [ 1 ] = mvLXM [ 1 ] \\ refIdxA = refIdxLXM \\ predListFlagA = X \qquad ( 26 )$$

Similarly, for the part B, X=(n&0x01). If a corresponding MV is unusable, an opposite MV is used. In this case, X=1−X. The obtained motion vector information of the part B is shown in the following formula.

$$mvB [ 0 ] = mvLXM [ 0 ] \\ mvB [ 1 ] = mvLXM [ 1 ] \\ refIdxB = refIdxLXN \\ predListFlagB = X \qquad ( 27 )$$

The obtained motion vector information of the two parts is separately used to perform unidirectional motion compensation prediction, to obtain unidirectional predicted values of the two parts.

2.1.2 GPM MMVD mode

In the GPM MMVD mode, a value of a motion vector of a part A and/or a part B of a CU is obtained by adding one offset to the items in the previously constructed GPM candidate list. The offset is derived from a limited set specified by the GPM_MMVD mode. Specifically, in the GPM MMVD mode, a unidirectional merge candidate list of GPM is first used to obtain a candidate list of a current block as initial MV candidates. An encoding end performs, by using a location at which the initial candidate MV points in a reference image (forward or backward) as a starting point, searching (72 MMVD searching modes in total) under nine steps (¼ pixel, ½ pixel, 1 pixel, 2 pixels, 3 pixels, 4 pixels, 6 pixels, 8 pixels, and 16 pixels) in eight candidate directions (four horizontal or vertical directions and four diagonal directions), to obtain a motion vector offset mvOffset. Note that when pic_fpel_mmvd_enabled_flag is equal to 0, the MVD step herein is shifted leftwards by two bits, that is, the MVD step is amplified by four times.

In a bitstream, two flags, that is, gpm_mmvd_flag0[x0][y0] and gpm_mmvd_flag1[x0][y0] are used to respectively identify whether geometric parts A and B use GPM MMVD to refine a motion vector. If gpm_mmvd_flag0[x0][y0]=1, a motion vector of the part A is obtained by adding a motion vector offset mvOffsetA to a motion vector in a GPM candidate list; if gpm_mmvd_flag1 [x0][y0]=1 a motion vector of the part B is obtained by adding a motion vector offset mvOffsetB to a motion vector in a GPM candidate list. The two flags gpm_mmvd_flag0[x0][y0] and gpm_mmvd_flag1 [x0][y0] may both be 1. In this case, the two geometric parts respectively refine motion vector candidates by using motion vector offsets offsetA and offsetB.

The part A is used as an example. When the part A uses the GPM_MMVD mode for prediction, first an initial motion vector mvA of the part A is constructed by using the l^{th} candidate L from the constructed unidirectional GPM merge list, where l is a unidirectional GPM merge index of the part A, merge_gpm_idx0 [xCb][yCb] represents an index, in the unidirectional merge list, of an MV of the part A that is actually entropy coded. In this case, mvA is obtained as follows:

$$l = merge\_gpm \_idxA [ xCb ] [ yCb ] \\ L = mergeCandList [ l ] \\ mvA = mvLXL \qquad ( 28 )$$

It is assumed that mmvdIdx is an index of an MMVD mode used by the part A. A step index geo_mmvd_distance_idx[x0][y0] and a search direction index geo_mmvd_direction_idx[x0][y0] of MMVD may be derived by using mmvdIdx, and a corresponding offset direction direction and a corresponding step step may be parsed by using the step index and the direction index. A motion vector offset value mvOffsetA of the part A in the GPM_MMVD mode is obtained by looking up a table according to the offset direction direction and the step step

$$mmvdIdx = geo\_mmvd \_idx [ xCb ] [ yCb ] \\ geo\_mmvd \_distance \_idx [ x 0 ] [ y 0 ] = mmvdIdx ≫ 3 \\ geo\_mmvd \_direction \_idx [ x 0 ] [ y 0 ] = mmvdIdx - ( geo\_mmvd \_distance \_idx [ x 0 ] [ y 0 ] ≪ 3 ) \\ direction = mmvdDirectionCand [ geo\_mmvd \_distance \_idx [ x 0 ] [ y 0 ] ] \\ step = mmvdStepCand [ geo\_mmvd \_direction \_idx [ x 0 ] [ y 0 ] ] \\ mvOffset = LUT ( direction , step ) \qquad ( 29 )$$

geo_mmvd_idx[xCb][yCb] represents a candidate index value in actual entropy coding of a part applying the GPM_MMVD mode.

dstmv is used to represent a final motion vector obtained after an offset is added to the MMVD mode. The obtained motion vector information of the part A is shown by the following formula.

$$dstmv = mvA + mvOffsetA \\ refIdx = refIdxLXL \\ predListFlag = X \qquad ( 30 )$$

refIdxA represents a reference index, in a unidirectional GPM merge candidate list of an initial motion vector of the part A in the GPM MMVD mode, and predListFlagA represents a prediction list flag of the part A.

Unidirectional motion compensation prediction is performed by using the refined dstmv, to obtain a unidirectional predicted value of the part A.

### 2.1.3 GPM TM Mode

The GPM TM mode is used for both parts of a current block, and motion vectors of both parts are motion information obtained by refining corresponding items in the previously constructed GPM candidate list by using a template matching (TM) method.

Specifically, initial MVs mvA, mvB of the two geometric parts of the current block are first obtained as corresponding items from the GPM merge candidate list. Then, reference templates of the two geometric parts at a current partitioning angle Partition_angle are obtained by looking up a table, as shown in Table 5, where A represents that an upper adjacent sample is used, L represents that a left adjacent sample is used, and L+A represents that both a left adjacent sample and an upper adjacent sample are used. Finally, based on mvA, mvB, within a specific offset range, MVs (half-pixel interpolation disabled) are refined by minimizing a difference between a template of a current coding unit or block and a template of a corresponding coding unit or block in a reference image, that is, motion vectors are further refined by using a matching cost between the template of the current block and the reference template, to obtain refined motion vectors mvA′, mvB′.

TABLE 5
Templates used by two parts at different partitioning angles

| Partition | 0 | 2 | 3 | 4 | 5 | 8 | 11 | 12 | 13 | 14 |
|---|---|---|---|---|---|---|---|---|---|---|
| 1 st partition | A | A | A | A | L + | L + A | L + A | L + A | A | A |
| 2 nd partition | L + A | L + A | L + A | L | L | L | L | L + A | L + A | L + A |
| Partition | 16 | 18 | 19 | 20 | 21 | 24 | 27 | 28 | 29 | 30 |
| 1 st partition | A | A | A | A | L + | L + A | L + A | L + A | A | A |
| 2 nd partition | L + A | L + A | L + A | L | L | L | L | L + A | L + A | L + A |

The motion vectors mvA′, mvB′ of the two parts are separately used to perform unidirectional motion compensation prediction, to obtain unidirectional predicted values of the two parts in the GPM mode.

2.1.4 GPM with Inter and Intra Mode

In the GPM with inter and intra encoding mode, one part is allowed to use the intra mode (as shown in FIG. 11a to FIG. 11c). When only one part uses the intra prediction mode (intra mode), the other part uses the conventional GPM mode or the GPM MMVD mode belonging to the inter prediction mode (inter mode).

The two geometric parts separately use GPMIntraFlag to indicate whether intra prediction or inter prediction is used. When GPMIntraFlag=1, the current part uses the intra prediction mode, and an IPM intra candidate mode list IPMCandList with a length of 3 needs to be adaptively constructed. Specifically, a source of a candidate item in the list includes an angle mode parallel to the dividing line (as shown in FIG. 11a), an angle mode perpendicular to the dividing line (as shown in FIG. 11b), and a planar intra prediction mode (as shown in FIG. 11c), and may be further derived by using DIMD or TIMD and/or derived from IPM information of an adjacent block. Duplicate detection and de-duplication are performed on these intra modes from different sources before the modes are added as IPM candidates.

If GPMIntraFlag=0, a predicted value of the current part comes from an inter prediction. In the conventional GPM mode, motion vector information mvA or mvB of a part that uses the inter prediction mode may be obtained from a unidirectional GPM candidate list that has been constructed, as shown in FIG. 12a. In the GPM MMVD mode, motion vector information mvA or mvB of a part that uses the inter prediction mode is obtained by adding one offset to an item of a GPM candidate list that has been constructed, as shown in FIG. 12b. A process of obtaining a motion vector of a part in GPM or GPM MMVD has been described in 2.1.1 and 2.1.2. Details are not described herein again. Unidirectional motion compensation is performed by using a motion vector mvA or mvB, to obtain a predicted value of the part that uses the inter prediction mode.

When a part uses the intra prediction mode for prediction, the intra prediction mode IntraMode needs to be obtained from an intra prediction mode IPM list obtained through adaptive derivation. Specifically, it is assumed that intra_gpm_idx[xCb][yCb] represents an index of the intra prediction mode in the IPM list IPMCandList that is used in actual entropy coding of a part using a GPM_Intra mode. k is an index, in the IPM list, of the intra mode used by the part in the GPM_Intra mode, and the intra prediction mode IntraMode used by the part in the GPM_Intra mode may be obtained by using this index.

$$k = intra\_gpm \_idx [ xCb ] [ yCb ] \\ IntraMode = IPMCandList [ k ] \qquad ( 31 )$$

A predicted pixel value of the part that uses the intra mode is obtained by using the selected intra prediction mode IntraMode. In this way, corresponding intra prediction values and corresponding inter prediction values are respectively obtained for the two GPM parts that respectively use the intra mode and the inter mode, and are used for weighted prediction of luma and chroma samples.

### 2.2 Acquisition of an Angle and a Step in GPM

In H.266 or VVC, when a current predicted block is in the GPM mode, a corresponding angle angleIdx and a corresponding step distanceIdx are obtained by looking up a table according to a partitioning mode index merge_gpm_partition_idx selected by the current block. Table 6 shows a mapping table of the partitioning mode.

TABLE 6
Mapping table between an angle and a step based on wedge_partition_idx

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

In ECM 5.0, a GPM partitioning rearrangement mode based on template matching is also introduced. In this mode, the GPM partitioning mode is rearranged based on TM, so that an Idx transmitted in a final bitstream becomes an index value of a selected partitioning mode in a template matching cost list. Detailed operations are as follows.

For a current block, on the premise that motion information of the current block is provided, first, for each possible partitioning mode, a dividing line of the current block is extended to a surrounding template formed by reconstructed pixels, and respective template costs of 64 partitioning modes are calculated.

Then, the 64 partitioning modes are sorted in descending order of the template costs, and the first 32 modes are used as optional modes.

An index of one partitioning mode in the 32 modes that is transmitted in the bitstream is encoded by Golmb-Rice.

Note that the calculation of the template costs does not use the hybrid edge weighted prediction described in the following section, but uses weight values of 1 or 0 to perform weighting on respective predicted values corresponding to two parts.

### 2.3 Hybrid GPM Weighted Prediction

In a hybrid GPM weighted prediction calculation process, in the current block, predicted values of pixels that are relatively far from the dividing line are predicted values obtained in the respective two parts, while predicted values of pixels near the dividing line are obtained by performing hybrid weighted prediction on the predicted values in the two parts according to specific weight values, where the weight values are related to distances between the pixels and the dividing line. That is, a weight of each pixel in the current block is obtained through calculation according to a distance between the respective pixel and the dividing line.

A specific implementation method currently used in VVC and ECM is as follows:

nCbW and nCbH represent a width and a height of a current block. When cIdx=0, a luma component is indicated; otherwise, a chroma component is indicated. SubWidthC and SubHeightC indicate a downsampling rate. If a 4:2:0 format is used, both SubWidthC and SubHeightC are 2. nW and nH are used for indicating the following shifting directions of the dividing line.

$$nW = ( cIdx == 0 ) ? nCbW : nCbW * SubWidthC \\ nH = ( cIdx == 0 ) ? nCbH : nCbH * SubHeightC \qquad ( 32 )$$

A distance from a point (x₁, y₁) to a line cos αx−sin αy=0 is d=cos αx₁−sin αy₁.

displacementX is an index number of α in cos(α) corresponding to an angle angleIdx obtained from the current block, and displacementY is an index number of (α+π/2) corresponding to a −sin(α)=cos(α+π/2) corresponding to the angle angleIdx

$$displacementX = angleIdx \qquad ( 36 )$$

$$displacementY = ( angleIdx + 8 ) \%32 \qquad ( 33 )$$

Related information of a first part (part0) and a second part (part1) is transmitted in a sequence in a bitstream. Therefore, sequence arrangement of the two parts must follow a principle, and partFlip is calculated by using the following formula:

$$partFlip = ( angleIdx >= 13 \&\& angleIdx <= 27 ) ? 0 : 1 \qquad ( 38 )$$

When partFlip is 0, it indicates that a side on which a distance weightIdx between a point obtained subsequently and a dividing line is a negative value is a part A, and a side opposite to the dividing line is a part B. When the value is 1, on the contrary, a side on which the distance weightIdx is a positive value is a part A, and a side on which the distance is a negative value is a part B.

$$shiftHor = ( angleIdx \%16 = 8 ▯ ( angleIdx \%16 != 0 \&\& nH >= nW ) ) ? 0 : 1 \qquad ( 39 )$$

A purpose of shiftHor is to determine shifting directions of different dividing lines at a same angle. When shiftHor is 0, a dividing line will be shifted on a Y-axis; when shiftHor is 1, a dividing line will be shifted on an X-axis.

An offset value offsetX and offsetY of a current block is calculated by using the following formula according to size and partitioning information of the current block.

When shiftHor=0:

$$offsetX = ( - nW ) ≫ 1 \qquad ( 34 )$$

$$offsetY = ( ( - nH ) ≫ 1 ) + ( angleIdx < 16 ? ( distanceIdx * nH ) ≫ 3 : - ( ( distanceIdx * nH ) ≫ 3 ) )$$

When shiftHor=1:

$$offsetX = ( - nW ) ≫ 1 + ( angleIdx < 16 ? ( distanceIdx * nH ) ≫ 3 : - ( ( distanceIdx * nH ) ≫ 3 ) ) \qquad ( 35 )$$

$$offsetY = ( ( - nH ) ≫ 1 )$$

A weight index weightIdx at a current pixel is calculated by using a location of the pixel, to obtain a weight value at the current pixel.

$$weightIdx = ( ( ( xL + offsetX ) ≪ 1 ) + 1 ) * disLut [ displacementX ] + ( ( ( yL + offsetY ) ≪ 1 ) + 1 ) * disLut [ displacementY ] \qquad ( 36 )$$

$$weightIdxL = partFlip ? 32 + weightIdx : 32 - weightIdx \qquad ( 37 )$$

$$wValue = Clip 3 ( 0 , 8 , ( weightIdxL + 4 ) ≫ 3 ) \qquad ( 38 )$$

disLut[ ] is shown in Table 7.

xL, yL may be obtained through calculation by using the following formula:

$$xL = ( cIdx == 0 ) ? x : x * SubWidthC \qquad ( 39 )$$

$$yL = ( cIdx == 0 ) ? y : y * SubHeightC$$

TABLE 7
Geometric partitioning distance search table

| idx | 0 | 2 | 3 | 4 | 5 | 6 | 8 | 10 | 11 | 12 | 13 | 14 |
|---|---|---|---|---|---|---|---|---|---|---|---|---|
| disLut[idx] | 8 | 8 | 8 | 4 | 4 | 2 | 0 | −2 | −4 | −4 | −8 | −8 |
| idx | 16 | 18 | 19 | 20 | 21 | 22 | 24 | 26 | 27 | 28 | 29 | 30 |
| disLut[idx] | −8 | −8 | −8 | −4 | −4 | −2 | 0 | 2 | 4 | 4 | 8 | 8 |

So far, a weight value wValue at each pixel of the current block is obtained, where weightTransitionWidthIdx=2, a transition width is 4, wMax=8, a weight range of wValue is {0,1,2,3,4,5,6,7,8}, and a weight value around a dividing line ranges from 0 to 8.

Pixel-by-pixel weighting is performed on the unidirectional predicted values of the two parts, that is, part0 and part1, to obtain a final GPM predicted block. Specific weighted calculation is shown by the following formula:

$$pbSamples [ x ] [ y ] = Clip 3 ( 0 , ( 1 ≪ BitDepth ) - 1 , \qquad ( 40 )$$

$$( predSamplesLA [ x ] [ y ] * wValue + predSamplesLB [ x ] [ y ] * ( 8 - wValue ) + offset 1 ) ≫ shift 1 )$$

offset1 and shift1 are calculated as follows: offset1 is used for rounding, and shift1 is used to restore a predicted value obtained by weighted averaging to a same bit depth as that in an input video, as shown by the following formula:

$$shift 1 = Max ( 5 , 17 - BitDepth ) \qquad ( 41 )$$

$$offset 1 = 1 ≪ ( shift 1 - 1 )$$

### 2.4 Storage of Motion Information

### 2.4.1 Storage of Motion Information in the GPM Mode

Motion information is stored in a unit of 4×4. A process of storing GPM motion information is implemented according to a motion mask matrix of a luma component of a current block. If a predicted value completely comes from part0, a motion vector of part0 is stored, or if a predicted value completely comes from part1, a motion vector of part1 is recorded. Otherwise, motion vectors of the two parts are both recorded.

cbWidth and cbHeight represent a width and a height of the luma component of the current block.

$$displacementX = angleIdx \qquad ( 42 )$$

$$displacementY = ( angleIdx + 8 ) \%32 \qquad ( 43 )$$

$$isFlip = ( angleIdx >= 13 \&\& angleIdx <= 27 ) ? 1 : 0 \qquad ( 44 )$$

$$shiftHor = ( \begin{matrix}angleIdx \%16 == 8 ▯ \\ ( angleIdx \%16 != 0 \&\& cbWidth >= cbHeight )\end{matrix} ) ? 0 : 1 \qquad ( 45 )$$

When shiftHor=0:

$$offsetX = ( - cbWidth ) ≫ 1 \qquad ( 52 )$$

$$offsetY = ( ( - cbHeight ) ≫ 1 ) + ( \begin{matrix}angleIdx < 16 ? \\ ( distanceIdx * cbHeight ) ≫ 3 : - ( ( distanceIdx * cbHeight ) ≫ 3 )\end{matrix} )$$

When shiftHor=1:

$$offsetX = ( - cbWidth ) ≫ 1 + ( \begin{matrix}angleIdx < 16 ? \\ ( distanceIdx * cbWidth ) ≫ 3 : - ( ( distanceIdx * cbWidth ) ≫ 3 )\end{matrix} ) \qquad ( 46 )$$

$$offsetY = ( ( - cbHeight ) ≫ 1 )$$

An index of a 4×4 subblock is (xSbIdx, ySbIdx), and, xSbIdx=0 . . . numSbX−1, ySbIdx=0 . . . numSbY−1. numSbX and numSbY respectively represent quantities of 4×4 blocks in horizontal and vertical directions in the current block, and numSbX=cbWidth□ 2, numSbY=cbHeight□ 2.

motionIdx of each location is shown by the following formula:

$$motionIdx = ( ( ( 4 * xSbIdx + offsetX ) ▯1 ) + 5 ) * disLut [ displacementX ] + ( ( ( 4 * ySbIdx + offsetY ) ▯1 ) + 5 ) * disLut [ displacementY ] \qquad ( 47 )$$

sType is used to indicate a part whose motion information is stored. If sType=0 motion information of part0 is stored; if sType=1, motion information of part1 is stored; if sType=2, combined motion information of part0 and part1 is stored.

$$sType = Abs ( motionIdx ) < 32 ? 2 : ( motionIdx <= 0 ? ( 1 - isFlip ) : isFlip ) \qquad ( 48 )$$

When sType=0:

$$predFlagL 0 = ( predListFlagA == 0 ) ? 1 : 0 \qquad ( 56 )$$

$$predFlagL 1 = ( predListFlagA == 0 ) ? 0 : 1$$

$$refIdxL 0 = ( predListFlagA == 0 ) ? refIdxA : - 1$$

$$refIdxL 1 = ( predListFlagA == 0 ) ? - 1 : refIdxA$$

$$mvL 0 [ 0 ] = ( predListFlagA == 0 ) ? mvA [ 0 ] : 0$$

$$mvL 0 [ 1 ] = ( predListFlagA == 0 ) ? mvA [ 1 ] : 0$$

$$mvL 1 [ 0 ] = ( predListFlagA == 0 ) ? 0 : mvA [ 0 ]$$

$$mvL 1 [ 1 ] = ( predListFlagA == 0 ) ? 0 : mvA [ 1 ]$$

When sType=1:

$$predFlagL 0 = ( predListFlagB == 0 ) ? 1 : 0 \qquad ( 49 )$$

$$predFlagL 1 = ( predListFlagB == 0 ) ? 0 : 1$$

$$refIdxL 0 = ( predListFlagB == 0 ) ? refIdxB : - 1$$

$$refIdxL 1 = ( predListFlagB == 0 ) ? - 1 : refIdxB$$

$$mvL 0 [ 0 ] = ( predListFlagB == 0 ) ? mvB [ 0 ] : 0$$

$$mvL 0 [ 1 ] = ( predListFlagB == 0 ) ? mvB [ 1 ] : 0$$

$$mvL 1 [ 0 ] = ( predListFlagB == 0 ) ? 0 : mvB [ 0 ]$$

$$mvL 1 [ 1 ] = ( predListFlagB == 0 ) ? 0 : mvB [ 1 ]$$

When sType=2:

$$predFlagL 0 = 1 \qquad ( 50 )$$

$$predFlagL 1 = 1$$

$$refIdxL 0 = ( predListFlagA == 0 ) ? refIdxA : refIdxB$$

$$refIdxL 1 = ( predListFlagA == 0 ) ? refIdxB : refIdxA$$

$$mvL 0 [ 0 ] = ( predListFlagA == 0 ) ? mvA [ 0 ] : mvB [ 0 ]$$

$$mvL 0 [ 1 ] = ( predListFlagA == 0 ) ? mvA [ 1 ] : mvB [ 1 ]$$

$$mvL 1 [ 0 ] = ( predListFlagA == 0 ) ? mvB [ 0 ] : mvA [ 0 ]$$

$$mvL 1 [ 1 ] = ( predListFlagA == 0 ) ? mvB [ 1 ] : mvA [ 1 ]$$

mvA, mvB represents motion vectors of the two parts, refIdxA, refIdxB represents reference indexes of the two parts, and predListFlagA, predListFlagB represents prediction list flags of the two parts. Finally, motion information of the current block is stored as shown by the following formula:

$$MvL 0 [ ( xSbIdx ≪ 2 ) + x ] [ ( ySbIdx ≪ 2 ) + y ] = mvL 0 \qquad ( 51 )$$

$$MvL 1 [ ( xSbIdx ≪ 2 ) + x ] [ ( ySbIdx ≪ 2 ) + y ] = mvL 1$$

$$MvDmvrL 0 [ ( xSbIdx ≪ 2 ) + x ] [ ( ySbIdx ≪ 2 ) + y ] = mvL 0$$

$$MvDmvrL 1 [ ( xSbIdx ≪ 2 ) + x ] [ ( ySbIdx ≪ 2 ) + y ] = mvL 1$$

$$RefIdxL 0 [ ( xSbIdx ≪ 2 ) + x ] [ ( ySbIdx ≪ 2 ) + y ] = refIdxL 0$$

$$RefIdxL 1 [ ( xSbIdx ≪ 2 ) + x ] [ ( ySbIdx ≪ 2 ) + y ] = refIdxL 1$$

$$PredFlagL 0 [ ( xSbIdx ≪ 2 ) + x ] [ ( ySbIdx ≪ 2 ) + y ] = predFlagL 0$$

$$PredFlagL 1 [ ( xSbIdx ≪ 2 ) + x ] [ ( ySbIdx ≪ 2 ) + y ] = predFlagL 1$$

$$BcwIdx [ ( xSbIdx ≪ 2 ) + x ] [ ( ySbIdx ≪ 2 ) + y ] = 0$$

x=xCb . . . xCb+3, y=yCb . . . yCb+3, and xCb, yCb indicates a location of the luma component of the current block in the upper left corner, where

$$sType = ( motionIdx <= 0 ? ( 1 - isFlip ) : isFlip ) \qquad ( 52 )$$

### 2.4.2 Storage of Motion Information in the GPM MMVD Mode

In the GPM MMVD mode, motion information is also stored in a unit of 4×4.

Specifically, in the GPM MMVD mode, a process of constructing a GPM merge candidate list is first used to obtain a candidate list of a current block as initial MV candidates. By using a location at which an initial candidate MV points in a reference image (forward or backward) as a starting point, searching (72 MMVD searching modes in total) is performed under nine steps (¼ pixel, ½ pixel, 1 pixel, 2 pixels, 3 pixels, 4 pixels, 6 pixels, 8 pixels, and 16 pixels) in eight candidate directions (four horizontal or vertical directions and four diagonal directions), to obtain a motion vector offset mvOffset. A candidate distance index fPosStep, and a candidate direction index fPosPosition are obtain by using an index mmvdIdx of the GPM_MMVD mode used by a current part, and thus a motion vector offset deltaMv may be obtained.

$$fPosStepIdx = mmvdIdx ≫ 3 \qquad ( 53 )$$

$$fPosPositionIdx = mmvdIdx - ( fPosStep ≪ 3 )$$

In different candidate directions, deltaMv is shown in Table 8. Note that when pic_fpel_mmvd_enabled_flag is equal to 0, the MVD step herein is shifted leftwards by two bits, that is, the MVD step is amplified by four times.

TABLE 8
Motion vector offsets in different candidate directions

| fPosPosition | deltaMv |
|---|---|
| 0 | Mv(refMvdCands[fPosStep], 0) |
| 1 | Mv(−refMvdCands[fPosStep], 0) |
| 2 | Mv(0, refMvdCands[fPosStep]) |
| 3 | Mv(0, −refMvdCands[fPosStep]) |
| 4 | Mv(refMvdCands[fPosStep], refMvdCands[fPosStep]) |
| 5 | Mv(refMvdCands[fPosStep], −refMvdCands[fPosStep]) |
| 6 | Mv(−refMvdCands[fPosStep], refMvdCands[fPosStep]) |
| 7 | Mv(−refMvdCands[fPosStep], −refMvdCands[fPosStep]) |

geoMMVDFlagA and geoMMVDFlagB represent GPM-MMVD mode flags of two parts, and predListFlagA, predListFlagB represents prediction list flags of the two parts.

When geoMMVDFlagA=1, the first part uses the GPM_MMVD mode.

When predFlagL0=1:

$$mvOffsetA [ 0 ] = delta \qquad ( 62 )$$

$$MvAL 0 [ ( xSbIdx ≪ 2 ) + x ] [ ( ySbIdx ≪ 2 ) + y ] = mvAL 0 + mvOffsetA [ 0 ]$$

When predFlagL1=1:

$$mvOffsetA [ 1 ] = delta \qquad ( 54 )$$

$$MvAL 1 [ ( xSbIdx ≪ 2 ) + x ] [ ( ySbIdx ≪ 2 ) + y ] = mvAL 1 + mvOffsetA [ 1 ]$$

When geoMMVDFlagB=1, the second part uses the GPM_MMVD mode.

When predFlagL0=1:

$$mvOffsetB [ 0 ] = delta \qquad ( 55 )$$

$$MvBL 0 [ ( xSbIdx ≪ 2 ) + x ] [ ( ySbIdx ≪ 2 ) + y ] = mvBL 0 + mvOffsetB [ 0 ]$$

When predFlagL1=1:

$$mvOffsetB [ 1 ] = delta \qquad ( 56 )$$

$$MvBL 1 [ ( xSbIdx ≪ 2 ) + x ] [ ( ySbIdx ≪ 2 ) + y ] = mvBL 1 + mvOffsetB [ 1 ]$$

$$RefIdxL 0 [ ( xSbIdx ≪ 2 ) + x ] [ ( ySbIdx ≪ 2 ) + y ] = refIdxL 0 \qquad ( 57 )$$

$$RefIdxL 1 [ ( xSbIdx ≪ 2 ) + x ] [ ( ySbIdx ≪ 2 ) + y ] = refIdxL 1$$

$$PredFlagL 0 [ ( xSbIdx ≪ 2 ) + x ] [ ( ySbIdx ≪ 2 ) + y ] = predFlagL 0$$

$$PredFlagL 1 [ ( xSbIdx ≪ 2 ) + x ] [ ( ySbIdx ≪ 2 ) + y ] = predFlagL 1$$

### 2.4.3 Storage of Motion Information in the GPM TM Mode

When a tmMergeFlag [x0][y0] flag is 1, the GPM_TM mode is selected for inter prediction. In this case, both parts use template matching for unidirectional prediction. Specifically, the two parts respectively use geoTmMrgCtx0 and geoTmMrgCtx1 to obtain unidirectional candidates mergeCtx0 and mergeCtx1 of the two parts that are selected by using a template matching cost. A specific process of storing a motion vector is consistent with that in the conventional GPM mode.

2.4.4 Storage of Motion Information in the GPM with Intra and Inter Mode

When a part uses an intra mode for prediction, in addition to storing motion information of the part (represented by an MV with a value of 0), intra prediction mode information of the part, that is, an IPM candidate, also needs to be stored.

When a part uses inter prediction, the conventional GPM mode or the GPM_MMVD technology may be selected. Storage of motion information of a current block in the two modes has been described in detail in 2.4.1 and 2.4.2, and details are not described herein again.

Information about a part that uses the intra mode for prediction is stored in a unit of 4×4.

cbWidth and cbHeight represent a width and a height of a luma component of the current block.

$$displacementX = angleIdx \qquad ( 67 )$$

$$displacementY = ( angleIdx + 8 ) \%32 \qquad ( 58 )$$

$$isFlip = ( angleIdx >= 13 \&\& angleIdx <= 27 ) ? 1 : 0 \qquad ( 59 )$$

$$shiftHor = ( \begin{matrix}angleIdx \%16 == 8 ▯ \\ ( angleIdx \%16 != 0 \&\& cbWidth >= cbHeight )\end{matrix} ) ? 0 : 1 \qquad ( 60 )$$

When shiftHor=0:

$$offsetX = ( - cbWidth ) ≫ 1 \qquad ( 61 )$$

$$offsetY = ( ( - cbHeight ) ≫ 1 ) + ( \begin{matrix}angleIdx < 16 ? \\ ( distanceIdx * cbHeight ) ≫ 3 : - ( ( distanceIdx * cbHeight ) ≫ 3 )\end{matrix} )$$

When shiftHor=1:

$$offsetX = ( - cbWidth ) ≫ 1 + ( \begin{matrix}angleIdx < 16 ? \\ ( distanceIdx * cbWidth ) ≫ 3 : - ( ( distanceIdx * cbWidth ) ≫ 3 )\end{matrix} ) \qquad ( 62 )$$

$$offsetY = ( ( - cbHeight ) ≫ 1 )$$

An index of a 4×4 subblock is (xSbIdx, ySbIdx) xSbIdx=0 . . . numSbX−1, and ySbIdx=0 . . . numSbY−1. numSbX and numSbY respectively represent quantities of 4×4 blocks in horizontal and vertical directions in the current block, and numSbX=cbWidth□ 2, numSbY=cbHeight□ 2.

motionIdx of each location is shown by the following formula:

$$motionIdx = ( ( ( 4 * xSbIdx + offsetX ) ▯1 ) + 5 ) * disLut [ displacementX ] + ( ( ( 4 * ySbIdx + offsetY ) ▯1 ) + 5 ) * disLut [ displacementY ] \qquad ( 63 )$$

tmpMask is used to indicate a part whose motion information is stored. If tmpMask=0, information about part0 is stored; if tmpMask=1, information of part1 is stored.

$$tmpMask = motionIdx <= 0 ? ( 1 - isFlip ) : isFlip \qquad ( 64 )$$

When (tmpMask=0&&isIntra0=1):

$$predFlagL 0 = 0 \qquad ( 75 )$$

$$predFlagL 1 = 0$$

$$refIdxL 0 = - 1$$

$$refIdxL 1 = - 1$$

$$mvL 0 [ 0 ] = 0$$

$$mvL 0 [ 1 ] = 0$$

In this case, in addition to storing motion vector information, intra prediction mode IPM information of the current block also needs to be stored. If IPM information of a part is available, the IPM information is directly stored. If IPM information of a current part is unavailable, IPM information of a corresponding location of a reference block needs to be found according to a location index and motion vector information of a current subblock, and stored as IPM information of a corresponding location of the current subblock.

When (tmpMask==0&&isIntra1=1):

$$predFlagL 0 = 0 \qquad ( 65 )$$

$$predFlagL 1 = 0$$

$$refIdxL 0 = - 1$$

$$refIdxL 1 = - 1$$

$$mvL 1 [ 0 ] = 0$$

$$mvL 1 [ 1 ] = 0$$

Storage of IPM information of the current block is shown as follows:

When geoIPM[0]>=0 Ipm=geolPM[0] Otherwise, the IPM information of the current part is unavailable.

When interDir!=3:

$$Ipm = getIpmInfo ( PosY ) \qquad ( 66 )$$

$$PosY . x = cbWidth + xSbIdx ≪ 2 + cMv 0. getHor$$

$$PosY . y = cbHeight + ySbIdx ≪ 2 + cMv 0. getVer$$

When interDir=3:

$$ipm 0 = getIpmInfo ( PosY 0 ) \qquad ( 67 )$$

$$ipm 1 = getIpmInfo ( PosY 1 )$$

$$PosY 0. x = xCb + xSbIdx ≪ 2 + cMv 0. getHor$$

$$PosY 0. y = yCb + ySbIdx ≪ 2 + cMv 0. getVer$$

$$PosY 1. x = xCb + xSbIdx ≪ 2 + cMv 1. getHor$$

$$PosY 1. y = yCb + ySbIdx ≪ 2 + cMv 1. getVer$$

xCb, yCb indicates a location of a luma component of the current block in the upper left corner, (xSbIdx, ySbIdx) indicates an index of each 4×4 subblock, cMv0, cMv1 indicates prediction motion vectors of the current block in forward and backward directions, PosY0, PosY1 indicates reference pixel locations of a current pixel in forward and backward directions, and ipm0,ipm1 indicates IPM information obtained from two prediction directions.

Final IPM information of the current block is selected from by using ipm0,ipm1 Table 9 and then stored.

TABLE 9
Storage of IPM

| condition | IPM |
|---|---|
| !mi0.isInter&& mi1.isInter | ipm0 |
| !mi1.isInter&& mi0.isInter | ipm1 |
| ipm0>DC IDX&& | ipm0 |
| ipm0<=DC_IDX&& | ipm1 |
| pocDiff0<pocDiff1 | ipm0 |
| pocDiff1<pocDiff0 | ipm1 |
| pRefPic0- | ipm1 |
| else | ipm0 |

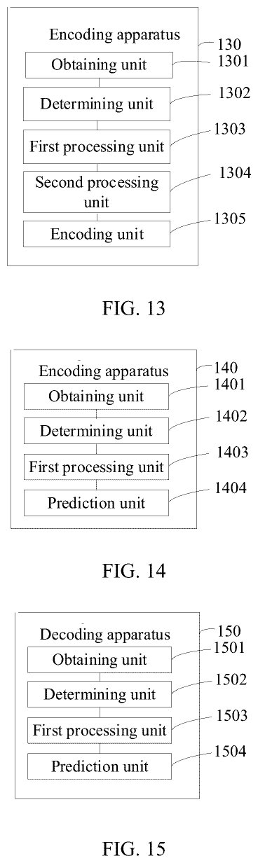

To implement the encoding methods in embodiments of this application, an embodiment of this application further provides an encoding apparatus based on a same invention concept. As shown in FIG. 13, the encoding apparatus 130 includes:
an obtaining unit 1301, configured to obtain, for a current block, a prediction parameter of a geometric partitioning mode;
a determining unit 1302, configured to determine, based on the prediction parameter, a plurality of candidate transition width parameters of a weight matrix of the current block;
a first processing unit 1303, configured to: determine, based on the prediction parameter, template matching cost parameters of the plurality of candidate transition width parameters; and sort the plurality of candidate transition width parameters according to the template matching cost parameters, to obtain index parameters of the plurality of candidate transition width parameters;
a second processing unit 1304, configured to determine a first transition width parameter actually used by the weight matrix of the current block from the plurality of candidate transition width parameters, where
the first processing unit 1303 is further configured to determine an index parameter of the first transition width parameter from the index parameters of the plurality of candidate transition width parameters; and
an encoding unit 1305, configured to encode the index parameter of the first transition width parameter, to obtain a bitstream.

In some embodiments, the first processing unit 1303 is configured to: obtain an actual template of the current block; obtain a reference template of a first part of the current block and a reference template of a second part of the current block; for a candidate transition width parameter among the plurality of candidate transition width parameters, obtain weight values of reference template pixels according to the candidate transition width parameter; perform pixel-by-pixel weighting on the reference template of the first part and the reference template of the second part according to the weight values for the reference template pixels, to obtain a reference template of the current block; and perform template matching on the actual template of the current block and the reference template of the current block, to obtain a template matching cost parameter.

In some embodiments, the first processing unit 1303 is configured to obtain reconstruction information of a related area of the current block as the actual template of the current block.

In some embodiments, the first processing unit 1303 is configured to: obtain first motion information of the first part when non-intra prediction is applied to the first part; determine a first reference block of the first part based on the first motion information; obtain reconstruction information of a related area of the first reference block as the reference template of the first part; and when intra prediction is applied to the first part, obtain reconstruction information of a related area of the current block as the reference template of the first part.

In some embodiments, the first processing unit 1303 is configured to: obtain second motion information of the second part when non-intra prediction is applied to the second part; determine a second reference block of the second part based on the second motion information; obtain reconstruction information of a related area of the second reference block as the reference template of the second part; and when intra prediction is applied to the second part, obtain reconstruction information of a related area of the current block as the reference template of the second part.

In some embodiments, the related area includes at least one of the following: an upper adjacent area, a left adjacent area, an upper left adjacent area, a lower left adjacent area, or an upper right adjacent area.

In some embodiments, the template matching cost parameters each include one of the following: a sum of absolute differences, a sum of squared differences, a mean absolute deviation, a mean squared difference mean squared error.

In some embodiments, the prediction parameter includes a geometric partitioning mode parameter of the current block; and the first processing unit 1303 is configured to: determine, based on the geometric partitioning mode parameter, distance parameters of the reference template pixels to an extension line of a dividing line of the current block; and determine the weight values for the reference template pixels based on the distance parameters and the candidate transition width parameter.

In some embodiments, the second processing unit 1304 is configured to: for a candidate transition width parameter among the candidate transition width parameters, obtain a weight value for a pixel of the current block according to the candidate transition width parameters; perform weighting on a first predicted value and a second predicted value of the current block according to the weight value of the pixel of the current block, to obtain a predicted value of the current block; determine, based on a preset matching criterion, an error parameter of an original value of the current block and the predicted value of the current block; and sort the plurality of candidate transition width parameters according to respective error parameters, and select a candidate transition width parameter corresponding to a least error parameter as the first transition width parameter.

In some embodiments, the prediction parameter includes a geometric partitioning mode parameter of the current block; and the second processing unit 1304 is configured to: determine, based on the geometric partitioning mode parameter, a distance parameter of the pixel of the current block to a dividing line of the current block; and determine the weight value of the pixel of the current block based on the distance parameter and the candidate transition width parameter.

In some embodiments, the second processing unit 1304 is configured to: when the respective candidate transition width parameter represents that a transition width is a non-zero pixel width, add the distance parameter and a half of the transition width, to obtain a translated distance parameter; divide the translated distance parameter by a ratio of the transition width to a maximum weight value, to obtain a first intermediate weight value; and when the first intermediate weight value is less than or equal to a minimum weight value, determine the minimum weight value as the weight value for the pixel of the current block; or when the first intermediate weight value is greater than or equal to the maximum weight value, determine the maximum weight value as the weight value for the pixel of the current block; or when the first intermediate weight value is greater than the minimum weight value and less than the maximum weight value, determine the first intermediate weight value as the weight value for the pixel of the current block.

In some embodiments, the second processing unit 1304 is configured to: when the candidate transition width parameter represents that a transition width is a non-zero pixel width, divide the distance parameter by a ratio of the transition width to a maximum weight value, to obtain a scaled distance parameter; add the scaled distance parameter and a half of the maximum weight value, to obtain a second intermediate weight value; and when the second intermediate weight value is less than or equal to a minimum weight value, determine the minimum weight value as the weight value for the pixel of the current block; or when the second intermediate weight value is greater than or equal to the maximum weight value, determine the maximum weight value as the weight value for the pixel of the current block; or when the second intermediate weight value is greater than the minimum weight value and less than the maximum weight value, determine the second intermediate weight value as a weight value of a second pixel.

In some embodiments, the second processing unit 1304 is further configured to: when the candidate transition width parameter represents that the transition width is a pixel width of 0, when the distance parameter is greater than 0, determine the maximum weight value as the weight value for the pixel of the current block; or when the distance parameter is less than or equal to 0, determine the minimum weight value as the weight value for the pixel of the current block.

In some embodiments, the transition width is a quantity of pixels, and the candidate transition width parameter is a logarithm of the transition width with a base of 2.

In some embodiments, the error parameter includes one of the following: a sum of absolute differences, a sum of squared differences, a mean absolute deviation, a mean squared difference, or a mean squared error.

In some embodiments, the second processing unit 1304 is further configured to: when the weight value is a minimum weight value, determine the predicted value of the current block to be equal to the first predicted value; or when the weight value is a maximum weight value, determine the predicted value of the current block to be equal to the second predicted value; or when the weight value is greater than the minimum weight value and less than the maximum weight value, perform a weighting operation by using the weight value as a weight value or the first predicted value and using a difference between the maximum weight value and the weight value as a weight value for the second predicted value, to obtain the predicted value of the current block.

In some embodiments, the determining unit 1302 is further configured to determine the maximum weight value based on the candidate transition width parameter.

In some embodiments, the determining unit 1302 is further configured to determine, based on a preset mapping relationship between transition width parameters and maximum weight values, the maximum weight value corresponding to the candidate transition width parameter.

In some embodiments, the prediction parameter includes a first syntax element used to indicate the plurality of candidate transition width parameters.

In some embodiments, the first syntax element is comprised in a sequence parameter set, a picture parameter set, a picture header data unit, a slice header data unit, or a current block data unit.

In some embodiments, the prediction parameter at least includes a size of the current block, a resolution of the current block, a quantization parameter of the current block, and a difference between motion vectors of two parts of the current block.

In some embodiments, the determining unit 1302 is further configured to determine, based on a second syntax element, whether to determine the first transition width parameter based on template matching.

In some embodiments, the second syntax element is comprised in a sequence parameter set, a picture parameter set, a picture header data unit, a slice header data unit, or a current block data unit.

In some embodiments, the index parameter of the first transition width parameter includes a first index parameter of a transition width group to which the first transition width parameter belongs and a second index parameter of the first transition width parameter in the transition width group to which the first transition width parameter belongs.

In some embodiments, the index parameter of the first transition width parameter is used to index some candidate transition width parameters whose template matching cost parameters are ranked in top N, and N is a positive integer.

To implement the encoding methods in embodiments of this application, an embodiment of this application further provides another encoding apparatus based on a same invention concept. As shown in FIG. 14, the encoding apparatus 140 includes:
an obtaining unit 1401, configured to obtain, for a current block, a prediction parameter of a geometric partitioning mode;
a determining unit 1402, configured to determine, based on the prediction parameter, a plurality of candidate transition width parameters of a weight matrix of the current block;
a first processing unit 1403, configured to: determine template matching cost parameters of the plurality of candidate transition width parameters; and sort the plurality of candidate transition width parameters according to the template matching cost parameters, and select a candidate transition width parameter corresponding to a least template matching cost parameter as the first transition width parameter; and
a prediction unit 1404, configured to: obtain a weight value for a pixel of the current block according to the first transition width parameter; and perform weighting on a first predicted value and a second predicted value of the current block according to the weight value for the pixel of the current block, to obtain a predicted value of the current block.

To implement the decoding methods in embodiments of this application, an embodiment of this application further provides a decoding apparatus based on a same invention concept. As shown in FIG. 15, the decoding apparatus 150 includes:
an obtaining unit 1501, configured to obtain, for a current block, a prediction parameter of a geometric partitioning mode;
a determining unit 1502, configured to determine, based on the prediction parameter, a plurality of candidate transition width parameters of a weight matrix of the current block;
a first processing unit 1503, configured to determine, based on template matching, a first transition width parameter actually used by the weight matrix of the current block from the plurality of candidate transition width parameters; and
a prediction unit 1504, configured to: obtain a weight value for a pixel of the current block according to the first transition width parameter; and perform weighting on a first predicted value and a second predicted value of the current block according to the weight value for the pixel of the current block, to obtain a predicted value of the current block.

In some embodiments, the decoding apparatus 150 further includes a decoding unit (not shown in FIG. 15), configured to decode a bitstream, to determine an index parameter of the first transition width parameter.

The first processing unit 1503 is configured to: determine, based on template matching, template matching cost parameters of the plurality of candidate transition width parameters; sort the plurality of candidate transition width parameters according to the template matching cost parameters, to obtain index parameters of the plurality of candidate transition width parameters; and determine, based on the index parameter of the first transition width parameter, the first transition width parameter from the plurality of candidate transition width parameters.

In some embodiments, the decoding unit is configured to: decode the bitstream, to determine a first index parameter of a transition width group to which the first transition width parameter belongs and a second index parameter of the first transition width parameter in the transition width group to which the first transition width parameter belongs; and obtain the index parameter of the first transition width parameter according to the first index parameter and the second index parameter.

In some embodiments, the index parameter of the first transition width parameter is used to index some candidate transition width parameters whose template matching cost parameters are ranked in top N, and N is a positive integer.

In some embodiments, the first processing unit 1503 is configured to: determine template matching cost parameters of the plurality of candidate transition width parameters; and sort the plurality of candidate transition width parameters according to the template matching cost parameters, and select a candidate transition width parameter corresponding to a least template matching cost parameter as the first transition width parameter.

In some embodiments, the first processing unit 1503 is configured to: obtain an actual template of the current block; obtain a reference template of a first part of the current block and a reference template of a second part of the current block; for a candidate transition width parameter among the plurality of candidate transition width parameters, obtain weight values of reference template pixels according to the candidate transition width parameter; perform pixel-by-pixel weighting on the reference template of the first part and the reference template of the second part according to the weight values of the reference template pixels, to obtain a reference template of the current block; and perform template matching on the actual template of the current block and the reference template of the current block, to obtain a template matching cost parameter.

In some embodiments, the first processing unit 1503 is configured to obtain reconstruction information of a related area of the current block as the actual template of the current block.

In some embodiments, the first processing unit 1503 is configured to: obtain first motion information of the first part when non-intra prediction is applied to the first part; determine a first reference block of the first part based on the first motion information; obtain reconstruction information of a related area of the first reference block as the reference template of the first part; and when intra prediction is applied to the first part, obtain reconstruction information of a related area of the current block as the reference template of the first part.

In some embodiments, the first processing unit 1503 is configured to: obtain second motion information of the second part when non-intra prediction is applied to the second part; determine a second reference block of the second part based on the second motion information; obtain reconstruction information of a related area of the second reference block as the reference template of the second part; and when intra prediction is applied to the second part, obtain reconstruction information of a related area of the current block as the reference template of the second part.

In some embodiments, the related area includes at least one of the following: an upper adjacent area, a left adjacent area, an upper left adjacent area, a lower left adjacent area, or an upper right adjacent area.

In some embodiments, the template matching cost parameters each include one of the following: a sum of absolute differences, a sum of squared differences, a mean absolute deviation, a mean squared difference mean squared error.

In some embodiments, the prediction parameter includes a geometric partitioning mode parameter of the current block.

The first processing unit 1503 is configured to: determine, based on the geometric partitioning mode parameter, distance parameters of the reference template pixels to an extension line of a dividing line of the current block; and determine the weight values of the reference template pixels based on the distance parameters and the candidate transition width parameter.

In some embodiments, the prediction parameter includes a geometric partitioning mode parameter of the current block; and the prediction unit 1504 is configured to: determine, based on the geometric partitioning mode parameter, a distance parameter of the pixel of the current block to a dividing line of the current block; and determine the weight value for the respective pixel of the current block based on the distance parameter and the first transition width parameter.

In some embodiments, the prediction unit 1504 is configured to: when the first transition width parameter represents that a transition width is a non-zero pixel width, add the distance parameter and a half of the transition width, to obtain a translated distance parameter; divide the translated distance parameter by a ratio of the transition width to a maximum weight value, to obtain a first intermediate weight value; and when the first intermediate weight value is less than or equal to a minimum weight value, determine the minimum weight value as the weight value for the pixel of the current block; or when the first intermediate weight value is greater than or equal to the maximum weight value, determine the maximum weight value as the weight value for the pixel of the current block; or when the first intermediate weight value is greater than the minimum weight value and less than the maximum weight value, determine the first intermediate weight value as the weight value for the pixel of the current block.

In some embodiments, the prediction unit 1504 is configured to: when the first transition width parameter represents that a transition width is a non-zero pixel width, divide the distance parameter by a ratio of the transition width to a maximum weight value, to obtain a scaled distance parameter; add the scaled distance parameter and a half of the maximum weight value, to obtain a second intermediate weight value; and when the second intermediate weight value is less than or equal to a minimum weight value, determine the minimum weight value as the weight value for the pixel of the current block; or when the second intermediate weight value is greater than or equal to the maximum weight value, determine the maximum weight value as the weight value for the pixel of the current block; or when the second intermediate weight value is greater than the minimum weight value and less than the maximum weight value, determine the second intermediate weight value as a weight value of a second pixel.

In some embodiments, the prediction unit 1504 is further configured to: when the first transition width parameter represents that the transition width is a pixel width of 0, when the distance parameter is greater than 0, determine the maximum weight value as the weight value for the pixel of the current block; or when the distance parameter is less than or equal to 0, determine the minimum weight value as the weight value for the pixel of the current block.

In some embodiments, the transition widths are quantities of pixels, and the first transition width parameter is a logarithm of the transition width with a base of 2.

In some embodiments, that the prediction unit 1504 is configured to perform weighting on a first predicted value and a second predicted value of the current block according to the weight value of the pixel of the current block, to obtain a predicted value of the current block by:
when the weight value is a minimum weight value, determining the predicted value of the current block to be equal to the first predicted value; or
when the weight value is a maximum weight value, determining the predicted value of the current block to be equal to the second predicted value; or
when the weight value is greater than the minimum weight value and less than the maximum weight value, performing a weighting operation by using the weight value as a weight value for the first predicted value and using a difference between the maximum weight value and the weight value as a weight value for the second predicted value, to obtain the predicted value of the current block.

In some embodiments, the prediction unit 1504 is configured to determine the maximum weight value based on the first transition width parameter.

In some embodiments, the prediction unit 1504 is configured to determine, based on a preset mapping relationship between transition width parameters and maximum weight values, the maximum weight value corresponding to the first transition width parameter.

It should be noted that, for details on a process in which the first processing unit 1503 determines the weight value of the pixel of the reference template and the weighting operation process, refer to a process in which the prediction unit 1504 determines the weight value of the pixel of the current block and a process of reference template and the weighting operation process, only the first transition width parameter needs to be replaced with a candidate transition width parameter.

In some embodiments, the prediction parameter includes a first syntax element used to indicate the plurality of candidate transition width parameters. In some embodiments, the first syntax element is comprised in a sequence parameter set, a picture parameter set, a picture header data unit, a slice header data unit, or a current block data unit.

In some embodiments, the prediction parameter includes a size of the current block, a resolution of the current block, a quantization parameter of the current block, and a difference between motion vectors of two parts of the current block.

In some embodiments, the determining unit 1502 is further configured to determine, based on a second syntax element, whether to determine the first transition width parameter based on template matching. In some embodiments, the second syntax element is comprised in a sequence parameter set, a picture parameter set, a picture header data unit, a slice header data unit, or a current block data unit.

It should be understood that the apparatus embodiments may correspond to the method embodiments, and for similar descriptions, refer to the method embodiments. To avoid repetition, details are not described herein again.

The foregoing describes the apparatuses and systems in embodiments of this application from a perspective of a functional unit with reference to the accompanying drawings. It should be understood that, the functional unit may be implemented in a hardware form, may be implemented by using instructions in a software form, or may be implemented by using a combination of hardware and a software unit. Specifically, the steps in the method embodiments in embodiments of this application may be completed by using an integrated logic circuit of hardware in a processor and/or instructions in a software form. The steps in the methods disclosed with reference to embodiments of this application may be directly performed by a hardware decoding processor, or may be performed by using a combination of hardware in the decoding processor and a software unit. Optionally, the software unit may be located in a mature storage medium in the art, such as a random access memory, a flash memory, a read-only memory, a programmable read-only memory, an electrically erasable programmable memory, or a register. The storage medium is located in a memory. The processor reads information from the memory, and performs the steps in the foregoing method embodiments in combination with hardware in the processor.

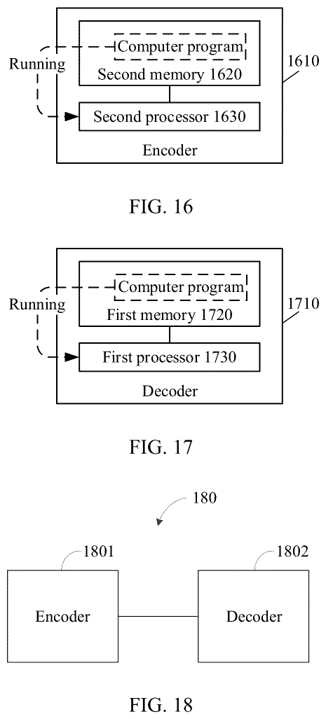

In actual application, an embodiment of this application further provides an encoder. FIG. 16 is a schematic block diagram of an encoder according to an embodiment of this application. As shown in FIG. 16, the encoder 1610 includes: a second memory 1620 and a second processor 1630, where the second memory 1620 stores a computer program that is runnable on the second processor 1630, and when executing the program, the second processor 1630 implements an encoding method on an encoding side.

In actual application, an embodiment of this application further provides a decoder. FIG. 17 is a schematic block diagram of a decoder according to an embodiment of this application. As shown in FIG. 17, the decoder 1710 includes: a first memory 1720 and a first processor 1730, where the first memory 1720 stores a computer program that is runnable on the first processor 1730, and when executing the program, the first processor 1730 implements a decoding method on a decoding side.

In some embodiments of this application, the processor may include but is not limited to a general-purpose processor, a digital signal processor (DSP), an application-specific integrated circuit (ASIC), a field-programmable gate array (FPGA) or another programmable logic device, a discrete gate or transistor logic device, a discrete hardware component, or the like.

In some embodiments of this application, the memory includes but is not limited to a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (synch link DRAM, SLDRAM), and a direct rambus random access memory (Direct Rambus RAM, DR RAM).

In addition, functional units in this embodiment may be integrated into one processing unit, or each of the units may exist alone physically, or two or more units may be integrated into one unit. The foregoing integrated unit may be implemented in a form of hardware, or may be implemented in a form of a software functional module.

In still another embodiment of this application, referring to FIG. 18, FIG. 18 is a schematic structural diagram of a codec system according to an embodiment of this application. As shown in FIG. 18, the codec system 180 may include an encoder 1801 and a decoder 1802. The encoder 1801 may be a device integrated with the encoding apparatus in the foregoing embodiments, and the decoder 1802 may be a device integrated with the decoding apparatus in the foregoing embodiments.

In this embodiment of this application, in the codec system 180, both the encoder 1801 and the decoder 1802 may use color component information of an adjacent reference pixel and a to-be-predicted pixel to implement calculation of a weighting coefficient corresponding to the to-be-predicted pixel. In addition, different reference pixels may have different weighting coefficients. Applying the weighting coefficients to chroma prediction of the to-be-predicted pixel in a current block may not only improve accuracy of the chroma prediction, but also improve performance of encoding and decoding.

An embodiment of this application further provides a chip, configured to implement the foregoing encoding and decoding methods. Specifically, the chip includes a processor, configured to invoke a computer program from a memory and run the computer program, to cause an electronic device installed with the chip to execute the foregoing encoding and decoding methods. An embodiment of this application further provides a computer storage medium, where the computer storage medium stores a computer program, and when being executed by a second processor, the computer program implements an encoding method of an encoder; or when being executed by a first processor, the computer program implements a decoding method of a decoder. Alternatively, an embodiment of this application further provides a computer program product that includes instructions, and when being executed by a computer, the instructions cause the computer to execute the methods in the foregoing method embodiments. This application further provides a bitstream. The bitstream is generated according to the foregoing encoding methods. Optionally, the bitstream includes an index parameter of a first transition width parameter actually used by a weight matrix of a current block.

When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

A person of ordinary skill in the art may be aware that, units and algorithm steps in examples described in combination with embodiments disclosed in this application be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual needs to achieve the objective of the solutions of embodiments. For example, function units in embodiments of this application may be integrated into one processing unit, or each of the units may exist alone physically, or two or more units may be integrated into one unit.

The foregoing contents are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL APPLICABILITY

This application provides an coding method and apparatus, an encoder, a decoder, and a storage medium, where the method includes: obtaining, for a current block, a prediction parameter of a geometric partitioning mode; determining, based on the prediction parameter, a plurality of candidate transition width parameters; determining, based on template matching, a first transition width parameter actually used by a weight matrix of the current block; obtaining a weight value for a pixel of the current block according to the first transition width parameter; and performing weighting on a first predicted value and a second predicted value of the current block according to the weight value, to obtain a predicted value of the current block. A plurality of candidate transition width parameters are sorted through template matching, and an optimal transition width parameter is selected from a sorting result for a current block, to determine an optimal weight matrix of the current block. Compared with a solution of using a fixed transition width, this solution can improve prediction accuracy of weighted prediction in GPM.

What is claimed is:

1. A decoding method, comprising:
obtaining, for a current block, a prediction parameter of a geometric partitioning mode;
determining, based on the prediction parameter, a plurality of candidate transition width parameters of a weight matrix of the current block;
determining, based on template matching, a first transition width parameter from the plurality of candidate transition width parameters;
obtaining a weight value for a sample of the current block according to the first transition width parameter; and
performing weighting on a first predicted value and a second predicted value of the current block according to the weight value for the sample of the current block, to obtain a predicted value of the current block.

2. The method according to claim 1, wherein the method further comprises:
decoding a bitstream, to determine an index parameter of the first transition width parameter; and
the determining, based on template matching, the first transition width parameter from the plurality of candidate transition width parameters comprises:
determining, based on template matching, template matching cost parameters of the plurality of candidate transition width parameters;
sorting the plurality of candidate transition width parameters according to the template matching cost parameters, to obtain index parameters of the plurality of candidate transition width parameters; and
determining, based on the index parameter of the first transition width parameter, the first transition width parameter from the plurality of candidate transition width parameters.

3. The method according to claim 2, wherein
the decoding a bitstream, to determine an index parameter of the first transition width parameter comprises:
decoding the bitstream, to determine a first index parameter of a transition width group to which the first transition width parameter belongs and a second index parameter of the first transition width parameter in the transition width group to which the first transition width parameter belongs; and
obtaining the index parameter of the first transition width parameter according to the first index parameter and the second index parameter.

4. The method according to claim 2, wherein the index parameter of the first transition width parameter is used to index some candidate transition width parameters whose template matching cost parameters are ranked in top N, where N is a positive integer.

5. The method according to claim 1, wherein the determining, based on template matching, a first transition width parameter from the plurality of candidate transition width parameters comprises:
determining, based on template matching, template matching cost parameters of the plurality of candidate transition width parameters; and
sorting the plurality of candidate transition width parameters according to the template matching cost parameters, and selecting a candidate transition width parameter corresponding to a least template matching cost parameter as the first transition width parameter.

6. The method according to claim 2, wherein the determining, based on template matching, template matching cost parameters of the plurality of candidate transition width parameters comprises:
obtaining an actual template of the current block;
obtaining a reference template of a first part of the current block and a reference template of a second part of the current block; and
for a candidate transition width parameter among the plurality of candidate transition width parameters,
obtaining weight values for reference template pixels according to the candidate transition width parameter;
performing pixel-by-pixel weighting on the reference template of the first part and the reference template of the second part according to the weight values for the reference template pixels, to obtain a reference template of the current block; and
performing template matching on the actual template of the current block and the reference template of the current block, to obtain a template matching cost parameter.

7. The method according to claim 6, wherein the obtaining an actual template of the current block comprises:
obtaining reconstruction information of a related area of the current block as the actual template of the current block.

8. The method according to claim 6,
wherein the obtaining the reference template of the first part of the current block comprises:
when non-intra prediction is applied to the first part,
obtaining first motion information of the first part;
determining a first reference block of the first part based on the first motion information; and
obtaining reconstruction information of a related area of the first reference block as the reference template of the first part; or
when intra prediction is applied to the first part, obtaining reconstruction information of a related area of the current block as the reference template of the first part; and
wherein the obtaining the reference template of the second part of the current block comprises:
when non-intra prediction is applied to the second part,
obtaining second motion information of the second part;
determining a second reference block of the second part based on the second motion information;
obtaining reconstruction information of a related area of the second reference block as the reference template of the second part; or
when intra prediction is applied to the second part, obtaining reconstruction information of a related area of the current block as the reference template of the second part.

9. The method according to claim 6, wherein the prediction parameter comprises a geometric partitioning mode parameter of the current block; and
the obtaining the weight values for the reference template pixels according to the candidate transition width parameter comprises:
determining, based on the geometric partitioning mode parameter, distance parameters of the reference template pixels to an extension line of a dividing line of the current block; and
determining the weight values for the reference template pixels based on the distance parameters and the candidate transition width parameter.

10. The method according to claim 1, wherein the prediction parameter comprises a geometric partitioning mode parameter of the current block; and
the obtaining a weight value for a sample of the current block according to the first transition width parameter comprises:
determining, based on the geometric partitioning mode parameter, a distance parameter of the sample of the current block to a dividing line of the current block; and
determining the weight value for the sample of the current block based on the distance parameter and the first transition width parameter.

11. The method according to claim 10, wherein the determining the weight value for the sample of the current block based on the distance parameter and the first transition width parameter comprises:
when the first transition width parameter represents that a transition width is a non-zero pixel width, adding the distance parameter and a half of the transition width, to obtain a translated distance parameter;
dividing the translated distance parameter by a ratio of the transition width to a maximum weight value, to obtain a first intermediate weight value; and
when the first intermediate weight value is less than or equal to a minimum weight value, determining the minimum weight value as the weight value for the sample of the current block; or
when the first intermediate weight value is greater than or equal to the maximum weight value, determining the maximum weight value as the weight value for the sample of the current block; or
when the first intermediate weight value is greater than the minimum weight value and less than the maximum weight value, determining the first intermediate weight value as the weight value for the sample of the current block.

12. The method according to claim 10, wherein the determining the weight value for the sample of the current block based on the distance parameter and the first transition width parameter comprises:
when the first transition width parameter represents that a transition width is a non-zero pixel width, dividing the distance parameter by a ratio of the transition width to a maximum weight value, to obtain a scaled distance parameter;
adding the scaled distance parameter and a half of the maximum weight value, to obtain a second intermediate weight value; and
when the second intermediate weight value is less than or equal to a minimum weight value, determining the minimum weight value as the weight value for the sample of the current block; or
when the second intermediate weight value is greater than or equal to the maximum weight value, determining the maximum weight value as the weight value for the sample of the current block; or
when the second intermediate weight value is greater than the minimum weight value and less than the maximum weight value, determining the second intermediate weight value as a weight value of the sample of the current block.

13. The method according to claim 11, wherein the determining the weight value for the sample of the current block based on the distance parameter and the first transition width parameter further comprises:
when the first transition width parameter represents that the transition width is a pixel width of 0,
when the distance parameter is greater than 0, determining the maximum weight value as the weight value for the sample of the current block; or
when the distance parameter is less than or equal to 0, determining the minimum weight value as the weight value for the sample of the current block.

14. The method according to claim 1, wherein the performing weighting on a first predicted value and a second predicted value of the current block according to the weight value for the sample of the current block, to obtain a predicted value of the current block comprises:
when the weight value is a minimum weight value, determining the predicted value of the current block to be equal to the first predicted value; or
when the weight value is a maximum weight value, determining the predicted value of the current block to be equal to the second predicted value; or
when the weight value is greater than the minimum weight value and less than the maximum weight value, performing a weighting operation by using the weight value as a weight value for the first predicted value and using a difference between the maximum weight value and the weight value as a weight value for the second predicted value, to obtain the predicted value of the current block.

15. An encoding method, comprising:
obtaining, for a current block, a prediction parameter of a geometric partitioning mode;
determining, based on the prediction parameter, a plurality of candidate transition width parameters of a weight matrix of the current block;
determining, based on template matching, template matching cost parameters of the plurality of candidate transition width parameters;
sorting the plurality of candidate transition width parameters according to the template matching cost parameters, to obtain index parameters of the plurality of candidate transition width parameters;
determining a first transition width parameter from the plurality of candidate transition width parameters;
determining an index parameter of the first transition width parameter from the index parameters of the plurality of candidate transition width parameters; and
encoding the index parameter of the first transition width parameter, to obtain a bitstream.

16. The method according to claim 15, wherein the determining, based on template matching, template matching cost parameters of the plurality of candidate transition width parameters comprises:
obtaining an actual template of the current block;
obtaining a reference template of a first part of the current block and a reference template of a second part of the current block;
for a candidate transition width parameter among the plurality of candidate transition width parameters,
obtaining weight values for reference template pixels according to the candidate transition width parameter;
performing pixel-by-pixel weighting on the reference template of the first part and the reference template of the second part according to the weight values for the reference template pixels, to obtain a reference template of the current block; and
performing template matching on the actual template of the current block and the reference template of the current block, to obtain a template matching cost parameter.

17. The method according to claim 16, wherein the obtaining an actual template of the current block comprises:
obtaining reconstruction information of a related area of the current block as the actual template of the current block.

18. The method according to claim 17,
wherein the obtaining a reference template of a first part of the current block comprises:
when non-intra prediction is applied to the first part,
obtaining first motion information of the first part;
determining a first reference block of the first part based on the first motion information;
obtaining reconstruction information of a related area of the first reference block as the reference template of the first part; or
when intra prediction is applied to the first part, obtaining reconstruction information of a related area of the current block as the reference template of the first part; and
wherein the obtaining a reference template of a second part of the current block comprises:
when non-intra prediction is applied to the second part,
obtaining second motion information of the second part;
determining a second reference block of the second part based on the second motion information; and
obtaining reconstruction information of a related area of the second reference block as the reference template of the second part; or
when intra prediction is applied to the second part, obtaining reconstruction information of a related area of the current block as the reference template of the second part.

19. The method according to claim 16, wherein the determining a first transition width parameter from the plurality of candidate transition width parameters comprises:
for a candidate transition width parameter among the candidate transition width parameters,
obtaining a weight value for a sample of the current block according to the candidate transition width parameter;
performing weighting on a first predicted value and a second predicted value of the current block according to the weight value of the sample of the current block, to obtain a predicted value of the current block; and
determining, based on a preset matching criterion, an error parameter of an original value of the current block and the predicted value of the current block; and
sorting the plurality of candidate transition width parameters according to respective error parameters, and selecting a candidate transition width parameter corresponding to a least error parameter as the first transition width parameter.

20. A bitstream, wherein the bitstream comprises an index parameter of a first transition width parameter.
